(19) United States
(12) Patent Application Publication
(10) Pub. No.: US 2026/0009682 A1
(43) Pub. Date: Jan. 8, 2026

(54) MULTI-MODAL-BASED ELECTRONIC DEVICE CAPABLE OF MULTI-ZONE SENSING AND OPERATING METHOD THEREOF

(71) Applicant: WILLOGCO., LTD., Seoul (KR)

(72) Inventors: Sunghoon BAE, Seoul (KR); Jihyun YUN, Seoul (KR); Jaehwan KIM, Seoul (KR)

(73) Assignee: WILLOGCO., LTD., Seoul (KR)

(21) Appl. No.: 19/128,595

(22) PCT Filed: Nov. 10, 2023
(86) PCT No.: PCT/KR2023/018116

§ 371 Date: May 9, 2025

(30) Foreign Application Priority Data
Nov. 10, 2022 (KR) 10-2022-0149744
Nov. 9, 2023 (KR) 10-2023-0154931
Nov. 9, 2023 (KR) 10-2023-0154932

(51) Int. Cl. G01K 1/024; G01K 13/00; G01K 15/00

(52) U.S. Cl. CPC G01K 1/024; G01K 13/00; G01K 15/005

(57) ABSTRACT

A multi-modal based electronic device according to the present disclosure may include at least one instructor and a memory storing a lookup table; a sensor subsystem configured to sense environmental information, including temperature or humidity, within different distances depending on the operating mode; and a processor configured to operate the electronic device by interpreting the instructor and directing the operating mode.

### FIELD OF THE INVENTION

The embodiments of the present disclosure relate to an electronic device, and more specifically, to a multi-modal-based electronic device capable of multi-zone sensing and an operating method thereof.

The embodiments of the present disclosure relate to a system comprising a counter and a sensing device, and more specifically, to a system comprising a counter and a sensing device for counting cargo inflow and outflow, and an operating method thereof.

### BACKGROUND OF THE RELATED ART

During the logistics transportation process, if products are damaged due to inappropriate levels of temperature, vibration, or humidity, other products within the logistics transportation space are also at a high risk of sequential damage. This risk is particularly critical for high-value products.

To address this issue, cargo visibility technology has emerged, in which an electronic device that measures temperature and humidity is attached to the logistics transportation space or directly to the product to visualize various information about the cargo status. However, electronic devices can only acquire information for specific location where the device is installed, resulting in low sensing precision for the overall space and requiring the deployment of multiple measurement devices. Additionally, when multiple sensing devices are placed in the cargo transportation space, it is difficult to directly count the amount of cargo placed and collected. Furthermore, when a worker manually attaches and detaches the sensing devices, some of these devices may be lost, misplaced, damaged, or not recovered.

The embodiments of the present disclosure aim to solve various issues, including the aforementioned problems, by providing a multi-modal-based electronic device capable of multi-zone sensing and an operating method thereof. However, these problems are merely exemplary and do not limit the scope of the present disclosure.

The embodiments of the present disclosure also aim to provide a system comprising a counter and a sensing device for counting cargo inflow and outflow, and an operating method thereof. However, these problems are merely exemplary and do not limit the scope of the present disclosure.

### SUMMARY OF THE INVENTION

According to one aspect of the present disclosure, a multi-modal-based electronic device is provided.

According to an embodiment, the multi-modal-based electronic device may include at least one instructor, memory storing a lookup table, a sensor subsystem configured to sense environmental information including temperature or humidity at different distances depending on the operating mode, and a processor configured to interpret the instructor, operate the electronic device, and direct the operating mode.

In the exemplary embodiment of the present disclosure, the operating mode may include a first mode defined to sense first environmental information within a first distance, and a second mode defined to sense second environmental information within a second distance that is relatively farther than the first distance.

In the exemplary embodiment, the sensor subsystem may sense the first environmental information for a first period at every first cycle in the first mode and operate in the second mode for at least part of the remaining time within the first cycle, excluding the first period.

In another embodiment, the electronic device operating in the second mode may be utilized for the correction of third environmental information sensed by another electronic device located within the second distance.

In yet another embodiment, the operating mode may further include a third mode defined to sense third environmental information within a third distance, which is the distance to a target item or target area.

The lookup table stored in the memory of the electronic device may include at least one of thermal conductivity, thermal convection, heat transfer quantity, heat transfer coefficient, heat transfer resistance, and heat conductance.

Additionally, the electronic device may be directly attached to the cargo loading space for transportation or directly to the cargo itself.

The electronic device may further include a communication module configured to support short-range communication with other electronic devices.

The operating method of the multi-modal-based electronic device for environmental information including temperature or humidity may include sensing first environmental information within the first distance according to the first mode, sensing second environmental information within a second distance, which is relatively farther than the first distance, during the time when the first environmental information is not being sensed according to the second mode, and sensing third environmental information within a third distance, which is the distance to a target item or target area, during the time when neither the first nor second environmental information is being sensed according to the third mode.

According to another aspect of the present disclosure, a system comprising a counter and at least one sensing device is provided.

In one embodiment, the system comprising a counter and at least one sensing device may include: a first sensing device including a first communication module configured to support communication, a sensor subsystem configured to sense environmental information including temperature or humidity, a first processor configured to process the sensing information, and a first memory storing a verification count variable (VRFCNT), a counter including a second communication module configured to support communication, a memory storing a count variable (COUNT), and a second processor configured to determine whether the sensing device has passed through communication.

In an exemplary embodiment, the counter may be installed in a gantry form to allow at least one sensing device to pass through.

Furthermore, the counter may initialize the count variable (COUNT) upon starting counting and determine whether a sensing device is detected within a predetermined time.

In another embodiment, the counter may update the count variable (COUNT) whenever at least one sensing device passes through.

The counter may determine whether the count value stored in the count variable satisfies a predetermined deployment condition after a set period of time.

If the deployment condition is met, the counter may generate and transmit a completion trigger externally, store the relative positions of each sensing device, and terminate counting.

If the deployment condition is not met, the counter may generate a verification trigger and transmit it to the first sensing device.

The first sensing device may update the verification count variable (VRFCNT) based on the relay communication count with other sensing devices deployed in the same space and respond with the total number of sensing devices within the given space as the verification count value.

The counter may determine a deployment status including cargo theft, non-retrieval of the sensing device, and an exception-handled successful deployment state based on the verification count value and the count value.

An exemplary operating method of the system comprising a counter and at least one sensing device may include initializing the count variable (COUNT) as counting begins, detecting at least one sensing device passing through a sensing region within a first distance of the counter, updating the count variable (COUNT) whenever at least one sensing device passes, determining whether the count value stored in the count variable satisfies a predetermined deployment condition after a set period, and generating either a completion trigger or a verification trigger depending on whether the deployment condition is met.

Other aspects, features, and advantages beyond those mentioned above will be evident from the detailed description, claims, and drawings for implementing the present invention. Additionally, these general and specific aspects may be implemented using a system, method, computer program, or any combination thereof.

According to the exemplary embodiments of the present disclosure, the multi-modal-based electronic device can sense environmental information, including temperature and humidity, for a distant space rather than being limited to the specific location where the device is installed, thereby improving sensing precision.

Furthermore, the temperature and humidity information of a specific location can be redundantly sensed not only by the immediately adjacent electronic device but also by an electronic device placed at a relatively farther distance, allowing for compensation in cases of malfunctions, measurement failures, or errors in the immediately adjacent electronic device.

Additionally, since the electronic device operates with a fixed sensing cycle, it can utilize its idle time for sensing other spaces, maximizing the efficiency of sensing resource utilization.

According to an exemplary embodiment of the present disclosure as described above, a system including a counter and a sensing device can easily count the number of sensing devices placed or collected in a cargo transport space or a cargo loading space when the counter is placed in the cargo transport space or the cargo loading space. In addition, since the counter electronically detects a sensing device passing through an adjacent location through communication, it is free from human error and can increase work efficiency.

Furthermore, when there is a discrepancy between the expected number of deployed sensing devices and the actual counted number, the system can generate a verification trigger instructing the sensing devices to self-connect and recount, ensuring accurate verification.

Moreover, in cases where the sensing device is directly attached to cargo, it becomes easier to determine whether the cargo itself has been lost or stolen. However, the scope of the present disclosure is not limited to these effects.

### BRIEF DESCRIPTION OF THE DRAWINGS

FIG. 1 is a block diagram schematically illustrating an electronic device according to an exemplary embodiment of the present disclosure.

FIG. 2 is a conceptual diagram schematically illustrating the relationship between a plurality of electronic devices according to an exemplary embodiment of the present disclosure.

FIG. 3 is a conceptual diagram schematically illustrating an electronic device disposed in a predetermined space according to an exemplary embodiment of the present disclosure.

FIG. 4 is a flowchart illustrating the sensing between electronic devices according to an exemplary embodiment of the present disclosure.

FIG. 5 is a conceptual diagram illustrating the operation mode of the sensing period of an electronic device according to an exemplary embodiment of the present disclosure.

FIG. 6 is a block diagram illustrating a data packet according to the operation mode of an electronic device according to an exemplary embodiment of the present disclosure.

FIG. 7 is a flowchart illustrating the operation method of an electronic device according to an exemplary embodiment of the present disclosure.

FIG. 8 is a conceptual diagram illustrating sensing based on different operation modes of an electronic device according to an exemplary embodiment of the present disclosure.

FIG. 9 is a table related to a lookup table referenced by an electronic device according to an exemplary embodiment of the present disclosure.

FIG. 10 is a block diagram schematically illustrating a system including a sensing device and a counter according to an exemplary embodiment of the present disclosure.

FIG. 11 is a conceptual diagram schematically illustrating the relationship between a plurality of sensing devices according to an exemplary embodiment of the present disclosure.

FIG. 12 is a conceptual diagram schematically illustrating a sensing device disposed in a predetermined space according to an exemplary embodiment of the present disclosure.

FIG. 13 is a flowchart illustrating the sensing between sensing devices according to an exemplary embodiment of the present disclosure.

FIG. 14 is a conceptual diagram illustrating the counting operation of a system using a sensing device and a counter according to an exemplary embodiment of the present disclosure.

FIGS. 15a, 15b, 15c, and 15d are conceptual diagrams illustrating the counting operation of a system using a sensing device and a counter according to an exemplary embodiment of the present disclosure.

FIG. 16 is a flowchart illustrating the operation of a system according to an exemplary embodiment of the present disclosure.

FIGS. 17a, 17b, 17c, and 17d are conceptual diagrams illustrating the counting operation of a system using a sensing device and a counter according to an exemplary embodiment of the present disclosure.

### DETAILED DESCRIPTION OF THE PREFERRED EMBODIMENT

The present disclosure may be subject to various modifications and may have multiple embodiments. Specific embodiments are illustrated in the drawings and will be described in detail in the following description. The effects and characteristics of the present disclosure, as well as the methods for achieving them, will be clarified through the embodiments described below with reference to the drawings. However, the present disclosure is not limited to the embodiments disclosed below and may be implemented in various forms.

In the following embodiments, terms such as “first” and “second” are used for distinguishing one component from another and do not impose any limitations. The singular expressions include plural meanings unless explicitly stated otherwise in the context.

Furthermore, the terms such as “comprising” or “having” indicate the presence of the features or components described and do not preclude the possibility of the presence or addition of one or more other features or components.

When a layer, region, or component is described as being “on” or “above” another component, it may be directly on the component or with other intermediate layers, regions, or components interposed in between.

For the convenience of explanation, the dimensions of components in the drawings may be exaggerated or reduced. For example, the size and thickness of each component shown in the drawings are arbitrarily depicted for convenience and are not necessarily limited to the exact depiction.

If a specific operation order may be implemented differently, two sequentially described steps may actually be performed simultaneously, or the order may be reversed.

The term “A and/or B” means either A, B, or both A and B. Also, the phrase “at least one of A and B” means either A, B, or both A and B.

When a layer, region, or component is described as being “connected” to another component, it includes both direct connections and indirect connections through other layers, regions, or components. Similarly, when described as being “electrically connected,” it includes both direct electrical connections and indirect electrical connections through other elements.

The x-axis, y-axis, and z-axis are not limited to being three orthogonal coordinate axes but may be interpreted. For example, the x-axis, y-axis, and z-axis may be orthogonal to each other, but they can also refer to different directions that are not orthogonal to each other.

The advantages, characteristics, and methods for achieving them in the present disclosure will be clarified by referring to the embodiments described below with reference to the drawings. However, the present disclosure is not limited to these embodiments and may be implemented in various forms. The described embodiments are provided to fully describe the disclosure and to enable those skilled in the art to fully understand the scope of the disclosure, which is defined only by the claims.

The terminology used herein is for the purpose of describing particular embodiments and is not intended to be limiting. The singular expressions include plural meanings unless explicitly stated otherwise. The terms “comprises” and “comprising” do not exclude the presence or addition of other components. Throughout the disclosure, the same reference numerals denote the same components, and “and/or” includes any combination of the mentioned components.

Although terms such as “first” and “second” are used to describe various components, these do not imply any limitation. They are used solely to distinguish one component from another. Therefore, the “first component” mentioned in the present disclosure may also be referred to as a “second component” within the technical scope of the disclosure.

The term “exemplary” as used in the present disclosure means “serving as an example or illustration.” Any embodiment described as “exemplary” should not necessarily be interpreted as preferred or superior over other embodiments.

Embodiments of the present disclosure may be described in terms of functional blocks. The blocks, referred to as “units” or “modules,” may be physically implemented by analog or digital circuits such as logic gates, integrated circuits, microprocessors, microcontrollers, memory, passive or active electronic components, optical components, hardwired circuits, or firmware/software-driven components. The term “unit” used in the present disclosure may refer to software elements, FPGA or ASIC-based hardware elements, or other elements that perform specific roles. However, a “unit” is not limited to software or hardware alone; it may be configured on an addressable storage medium or be executable by one or more processors. Thus, as an example, a “unit” may include elements such as software elements, object-oriented software elements, class elements, and task elements, processes, functions, attributes, procedures, subroutines, segments of program code, drivers, firmware, microcode, circuitry, data, databases, data structures, tables, arrays, and variables. The functionality provided within the elements and “units” may be combined into a smaller number of elements and “units” or further separated into additional elements and “units”.

Embodiments of the present disclosure may be implemented using at least one software program running on at least one hardware device and may perform network management functions for controlling elements.

Spatially relative terms such as “below,” “beneath,” “lower,” “above,” and “upper” may be used to facilitate the description of the relationships between components. However, these terms should be interpreted to include different orientations depending on usage or operation. For example, when a component depicted in a drawing is flipped, a component described as “below” or “beneath” another component may end up being “above” the other component. Thus, the exemplary term “below” may include both the above and below directions. Components may also be oriented in other directions, and thus spatially relative terms may be interpreted according to the orientation.

Unless otherwise defined, all terms used in this disclosure (including technical and scientific terms) are intended to have meanings commonly understood by those skilled in the field. Moreover, general dictionary definitions should not be overly idealized or restricted unless explicitly stated.

The following embodiments of the present disclosure will be described in detail with reference to the accompanying drawings. In doing so, the same reference numerals denote the same or corresponding components, and redundant descriptions will be omitted.

### 1. Example 1

The following example describes a multi-modal-based electronic device capable of multi-area sensing and its operation method.

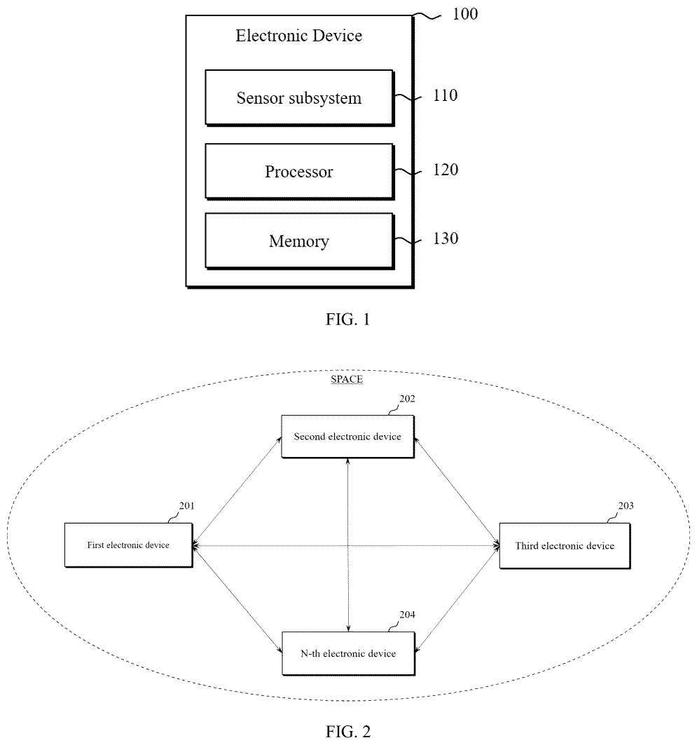

FIG. 1 is a block diagram schematically illustrating an electronic device 100 according to an exemplary embodiment of the present disclosure. According to an exemplary embodiment, the electronic device 100 may be a device to which cargo visibility technology is applied, enabling visualization of various information regarding cargo conditions by measuring temperature, humidity, etc., within a predetermined space or directly on a product.

Referring to FIG. 1, the electronic device 100 may include a sensor subsystem 110, a processor 120, and a memory 130.

The sensor subsystem 110 may include at least one of a temperature sensor, an illumination sensor, a humidity sensor, a proximity sensor, an acceleration sensor, a gravity sensor (G-sensor), a gyroscope sensor, a motion sensor, an infrared sensor (IR sensor), a fingerprint recognition sensor (finger scan sensor), an optical sensor, an ultrasonic sensor, an infrared ray sensor, a magnetic sensor, an RGB sensor (illuminance sensor), a LiDAR (radar) sensor, a current sensor, an environmental sensor (e.g., a pressure sensor, a radiation detection sensor, a thermal detection sensor, a gas detection sensor, etc.), a chemical sensor (e.g., a healthcare sensor, a biometric sensor, a gas leakage monitoring sensor, etc.), and virtual sensors that perform functions corresponding to the hardware sensors, but is not limited thereto.

Here, the proximity sensor may detect the presence or absence of an object approaching a predetermined detection surface or an object present nearby without mechanical contact, using electromagnetic force or infrared rays. These sensors may be embedded in at least one unit inside the sensor subsystem 110. The functions of each sensor can be intuitively inferred by a person skilled in the art from their respective names, and thus, detailed descriptions thereof will be omitted.

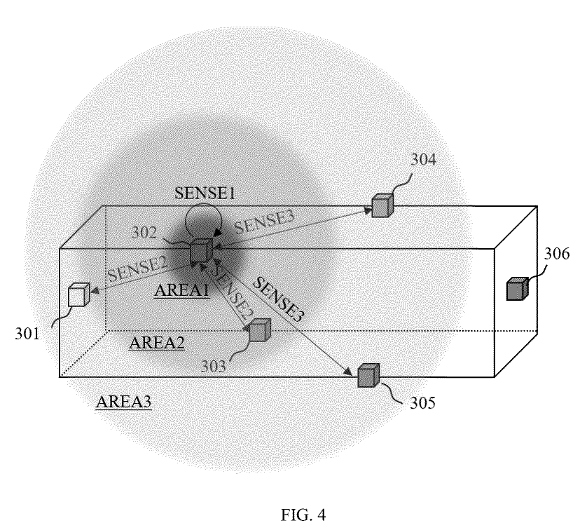

According to an exemplary embodiment of the present disclosure, the sensor subsystem 110 may be configured to sense environmental information, including temperature or humidity, within different distances depending on the operating mode. The specific operation will be described in more detail with reference to FIG. 4.

The processor 120 processes, compresses, corrects, and estimates data sensed within the transport space by the sensing subsystem 110, and generally controls the operation of the electronic device 100, such as converting the sensed data into N-dimensional information and displaying it on a screen. The processor 120 may communicate with the memory 130 and execute at least one instruction stored in the memory 130.

According to an exemplary embodiment of the present disclosure, the processor 120 may interpret the instruction set to operate the electronic device 100 and direct the operating mode. In an exemplary embodiment, the operating modes may include a first mode defined to sense first environmental information within a first distance, a second mode defined to sense second environmental information within a second distance farther than the first distance, and a third mode defined to sense third environmental information within a third distance corresponding to the distance to a target item or target area, and may further include various other sensing modes.

The processor 120 may perform the above-described operations using the memory 130, which stores data related to an algorithm for controlling the operation of the components within the device or a program that reproduces the algorithm. The memory 130 and processor 120 may be implemented as separate chips or as a single chip.

The processor 120 may comprise one or multiple cores. In this case, one or more processors may include a general-purpose processor such as a CPU, AP, or DSP (Digital Signal Processor), a graphics-dedicated processor such as a GPU or VPU (Vision Processing Unit), or an artificial intelligence-dedicated processor such as an NPU. One or more processors may be controlled to process input data according to predefined operation rules of artificial intelligence models stored in memory. If one or more processors are artificial intelligence-dedicated processors, they may be designed with a hardware structure specialized for processing a specific artificial intelligence model.

The memory 130 may store data supporting various functions of the device, programs for controlling its operation, input/output data (e.g., music files, still images, videos, etc.), multiple applications running on the system, and data and commands necessary for operating the device. At least some of these applications may be downloaded from an external server via wireless communication.

The memory 130 may store at least one instruction and may include one or more of the following types of storage media: flash memory, hard disk type, SSD type (Solid State Disk), SDD type (Silicon Disk Drive), multimedia card micro type, card-type memory (e.g., SD or XD memory), RAM (random access memory), SRAM (static random access memory), ROM (read-only memory), EEPROM (electrically erasable programmable read-only memory), PROM (programmable read-only memory), magnetic memory, magnetic disk, and optical disk. Additionally, the memory 130 may be a database that is separate from the system but connected via wired or wireless communication.

The components shown in FIG. 1 are not essential for implementing the multi-modal-based electronic device capable of multi-area sensing and its operation method according to the present disclosure. The described configuration may include more or fewer components than those listed above.

The electronic device 100 may generate sensing data (or sensing information) by sensing at least one of temperature, acceleration, humidity, illumination, inclination, shock, and position inside a predetermined space (e.g., a cargo loading space or cargo transport space) where the transport-target cargo is loaded, through the sensor subsystem 110 installed inside the space. For example, the electronic device 100 may generate sensing data in real time or at preset intervals. It may calculate a variation amount at preset time intervals for the actual sensed data and activate either a first storage mode or a second storage mode based on a comparison result between the variation amount and a preset threshold variation amount.

According to an exemplary embodiment, the electronic device 100 may store sensing data in the storage method provided by the activated storage mode. Accordingly, the electronic device 100 may provide a method of storing logistics status information, such as temperature, acceleration, humidity, illumination, inclination, shock, and position inside a delivery vehicle, in a preset storage method, thereby reducing the data capacity required to store and manage logistics status information.

Furthermore, since the status information stored in an electronic code (e.g., a QR code or barcode) is compressed, more data can be stored on a single page, improving logistics-related operational efficiency. The electronic code here includes barcodes, two-dimensional codes such as QR codes, holograms, depth-camera-based three-dimensional codes, and is not limited in its implementation form.

In this disclosure, the electronic device 100 can be attached and detached directly to a predetermined space or cargo, allowing it to be affixed to a logistics transport space and retrieved for reuse after transportation is completed. In an exemplary embodiment, at least one electronic device 100 may be placed (attached) inside a logistics transport space.

According to an embodiment of the present disclosure, the electronic device 100 may optionally include a communication module (not shown). The communication module (not shown) may transmit various information acquired in the transport space and/or transport environment to other electronic devices, other terminals, or a server. For example, the communication module (not shown) may transmit at least one type of sensing data, such as temperature data, humidity data, vibration data, illumination data, acceleration data, gravity data, or gas data sensed by the sensor subsystem 110, to another electronic device, another terminal, or a server.

The communication module (not shown) can communicate with external devices. Therefore, the electronic device 100 can transmit and receive information with external devices through the communication unit. For example, the electronic device 100 can use the communication module (not shown) to communicate with external devices, allowing the sharing of information sensed and generated within a logistics transportation environment. The communication module (not shown) may include at least one of a wired communication module, a wireless communication module, a short-range communication module, and a location information module. In an exemplary embodiment of the present disclosure, the communication module may be configured to support short-range communication with other electronic devices.

According to an exemplary embodiment of the present disclosure, the communication module (not shown) can communicate with other logically connected electronic devices. Through processing by the processor 120, the communication module (not shown) can determine that another electronic device is logically connected and use various wireless communication methods, including short-range communication, to transmit and receive various types of information, such as sensing data, location information, and cargo information.

Here, communication, that is, data transmission and reception, may be conducted via wired or wireless connections. To this end, the communication unit may include a wired communication module that connects to the Internet via a Local Area Network (LAN), a mobile communication module that connects to a mobile communication network via a mobile communication base station, a short-range communication module using wireless communication methods such as Wi-Fi (Wireless LAN), Bluetooth, or Zigbee (WPAN: Wireless Personal Area Network), a satellite communication module using GNSS (Global Navigation Satellite System) such as GPS, or a combination thereof. The wireless communication technology used for communication may include NB-IoT (Narrowband Internet of Things) for low-power communication. For example, NB-IoT technology is an example of LPWAN (Low Power Wide Area Network) technology and may be implemented according to LTE Cat (category) NB1 and/or LTE Cat NB2 standards, though it is not limited to these names.

In an exemplary embodiment of the present disclosure, communication may include Bluetooth Low Energy (BLE) for low-power communication. BLE, for example, may feature a duty cycle of a few milliseconds and remain in sleep mode for most of the time, thereby consuming very little power.

Additionally, or alternatively, the wireless communication technology implemented in various embodiments of wireless devices may be based on LTE-M or 5G technology. For example, LTE-M technology is an example of LPWAN technology and may be referred to by various names, including enhanced Machine Type Communication (eMTC). LTE-M technology may be implemented in at least one of the following standards: 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, though it is not limited to these names.

Additionally, or alternatively, wireless communication technology implemented in various embodiments of wireless devices may include at least one of ZigBee, Bluetooth, or LPWAN (Low Power Wide Area Network) for low-power communication, though it is not limited to these names. For example, ZigBee technology can create personal area networks (PANs) related to small-scale/low-power digital communication based on IEEE 802.15.4 or other standards.

The wired communication module may include various wired communication modules such as a Local Area Network (LAN) module, a Wide Area Network (WAN) module, or a Value Added Network (VAN) module. In addition, it may include various cable communication modules such as USB (Universal Serial Bus), HDMI (High Definition Multimedia Interface), DVI (Digital Visual Interface), RS-232 (Recommended Standard 232), power line communication, or POTS (Plain Old Telephone Service).

The wireless communication module may include a Wi-Fi module, a WiBro (Wireless broadband) module, and various other wireless communication modules supporting communication methods such as GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long Term Evolution), 4G, 5G, and 6G.

The wireless communication module may include a wireless communication interface comprising an antenna and a transmitter for transmitting signals. Furthermore, the wireless communication module may include a signal conversion module that modulates digital control signals output from the control unit into analog wireless signals through the wireless communication interface under the control of the control unit.

The wireless communication module may also include a wireless communication interface comprising an antenna and a receiver for receiving signals. Furthermore, the wireless communication module may include a signal conversion module that demodulates analog wireless signals received through the wireless communication interface into digital control signals.

The short-range communication module is designed for short-range communication and may support short-range communication using at least one of Bluetooth™, RFID (Radio Frequency Identification), Infrared Data Association (IrDA), UWB (Ultra-WideBand), ZigBee, NFC (Near Field Communication), BLE (Bluetooth Low Energy), Wi-Fi (Wireless Fidelity), Wi-Fi Direct, or Wireless USB (Wireless Universal Serial Bus).

The communication module (not shown) may further include a location information module. The location information module is a module for acquiring the location (or current location) of the electronic device 100 according to the present disclosure. A representative example of such a module includes a GPS (Global Positioning System) module or a Wi-Fi (Wireless Fidelity) module. For example, by utilizing a GPS module, the location of the electronic device can be determined using signals from GPS satellites. Alternatively, by using a Wi-Fi module, the location of the electronic device 100 can be determined based on information from a wireless access point (AP) transmitting or receiving wireless signals with the Wi-Fi module. If necessary, the t location information module may perform some functions of other modules in the communication unit to obtain data related to the location of the device, either as a substitute or in addition. The location information module is not limited to a module that directly calculates or acquires the device's location but is a module used to obtain the device's location (or current location).

Although not shown in FIG. 1, the electronic device 100 may further include functional units necessary for sensing and displaying information, such as a display and input/output devices.

According to an exemplary embodiment, the input/output unit may include various interfaces or connection ports for receiving user input or outputting information to the user. The input/output unit may be divided into an input module and an output module.

The input module receives user input. It is designed to input image information (or signals), audio information (or signals), data, or other user-inputted information and may include at least one camera, at least one microphone, and at least one user input unit. The image or voice data collected from the input unit may be analyzed and processed as a user control command.

User input may take various forms, including key input, touch input, and voice input. Examples of input modules capable of receiving such user input include traditional keypads or keyboards, mice, touch sensors that detect user touch, microphones for receiving voice signals, cameras for recognizing gestures through image recognition, proximity sensors such as light sensors or infrared sensors for detecting user approach, motion sensors such as accelerometers or gyroscopic sensors for detecting user movements, and other various input means for detecting and receiving user input.

The module provided in the electronic device 100 according to an exemplary embodiment is designed to receive information from the user. When information is entered through the input module, the processor 120 can control the operation of this device accordingly. The user input unit may include hardware-based physical keys (e.g., buttons, dome switches, jog wheels, jog switches, etc.) positioned on at least one of the front, rear, or side surfaces of the device, as well as software-based touch keys. For example, touch keys may be implemented as virtual keys, soft keys, or visual keys displayed on a touchscreen display via software processing, or as touch keys positioned in areas other than the touchscreen. The virtual or visual keys may take various forms when displayed on the touchscreen, including graphics, text, icons, videos, or combinations thereof.

The touch sensor in an exemplary embodiment may be implemented as a piezoelectric or capacitive touch sensor that detects touch input through a touch panel or touch film attached to the display panel, or as an optical touch sensor that detects touch input using optical methods. Additionally, the input module may be configured as an input interface (such as a USB port or PS/2 port) that connects to an external input device rather than detecting user input on its own.

The output module provides various types of information to the user. It is a broad concept encompassing display screens for visual output, speakers (and/or connected amplifiers) for audio output, haptic devices for vibration feedback, and other forms of output means. The output module may also be implemented as an interface port that connects to individual output devices.

For example, a display-type output module can display text, still images, and videos. The display may include various types such as an LCD (Liquid Crystal Display), LED (Light Emitting Diode) display, OLED (Organic Light Emitting Diode) display, FPD (Flat Panel Display), transparent display, curved display, flexible display, 3D display, holographic display, projectors, and other devices capable of visual output. This display may also be integrated with a touch sensor to form a touch display.

According to an exemplary embodiment, the information processed in the electronic device 100 may be transmitted to a user's terminal or a server (including cloud servers) for post-processing.

The user terminal may include both computers and portable devices or take the form of either. Here, the computer may include, for example, a laptop, desktop, tablet PC, slate PC, or any other device equipped with a web browser. Portable user terminals may include wireless communication devices ensuring portability and mobility, such as PCS (Personal Communication System), GSM (Global System for Mobile Communications), PDC (Personal Digital Cellular), PHS (Personal Handyphone System), PDA (Personal Digital Assistant), IMT-2000 (International Mobile Telecommunication-2000), CDMA-2000 (Code Division Multiple Access-2000), W-CDMA (Wideband Code Division Multiple Access), WiBro (Wireless Broadband Internet) devices, smartphones, and all other types of handheld wireless communication devices. Additionally, wearable devices such as watches, rings, bracelets, anklets, necklaces, glasses, contact lenses, or head-mounted devices (HMDs) may also be included.

The server, for instance, may be a server that processes information by communicating with external devices, such as an application server, computing server, database server, file server, game server, mail server, proxy server, or web server.

FIG. 2 schematically illustrates the interrelationship between multiple electronic devices in accordance with an exemplary embodiment of the disclosure.

According to an exemplary embodiment, multiple electronic devices 201, 202, 203, 204 may be arranged in a predefined space (SPACE). The predefined space (SPACE) in this disclosure may refer to physically partitioned spaces such as the cargo hold of a freight vehicle, the cargo storage of an airplane or ship, a container box transportation space, a reefer container, a liner, or any space where cargo is transported. However, the definition is not limited to physically separated spaces but may also include areas within a certain distance from a particular electronic device, even if no physical barriers exist.

Referring to FIG. 2, the predefined space (SPACE) may include a first electronic device 201, a second electronic device 202, a third electronic device 203, and an N-th electronic device 204.

The first electronic device 201 can sense environmental information such as temperature and humidity in the space where other electronic devices are located. For example, the first electronic device 201 can sense the environmental conditions at the locations of the second electronic device 202, the third electronic device 203, and the N-th electronic device 204. Likewise, the second electronic device 202 can sense the conditions at the locations of the first electronic device 201, the third electronic device 203, and the N-th electronic device 204. Similarly, the third electronic device 203 can sense the conditions at the locations of the first electronic device 201, the second electronic device 202, and the N-th electronic device 204. The N-th electronic device 204 can sense the conditions at the locations of the first electronic device 201, the second electronic device 202, and the third electronic device 203.

In an exemplary embodiment, each individual electronic device can perform short-range communication with nearby electronic devices via a communication network 20, long-range mobile communication, or relay communication through a gateway. In this case, the communication module among these components may include one or more components enabling communication with external devices, such as a broadcast receiving module, wired communication module, wireless communication module, short-range communication module, or location information module. The wireless communication module may support various wireless communication technologies, including Wi-Fi, WiBro (Wireless Broadband), GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long-Term Evolution), 4G, 5G, 6G, and others.

The wireless communication module may include a wireless communication interface comprising an antenna and a transmitter for transmitting mobile communication signals. Additionally, under the control of the control unit, the wireless communication module may further include a mobile communication signal conversion module that modulates digital control signals output from the control unit into analog wireless signals. The wireless communication module may also include an antenna and a receiver for receiving mobile communication signals through a wireless communication interface. Furthermore, the wireless communication module may include a mobile communication signal conversion module that demodulates received analog wireless signals into digital control signals through the wireless communication interface.

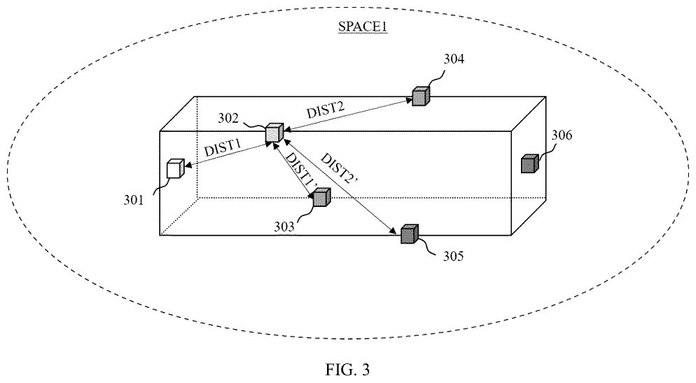

FIG. 3 schematically illustrates the arrangement of electronic devices within a predefined space (SPACE1) according to an exemplary embodiment. Although FIG. 3 depicts six electronic devices 301, 302, 303, 304, 305, 306 for convenience, the technical concept of this disclosure is not limited thereto, and various numbers of electronic devices and arrangement configurations may be implemented.

Referring to FIG. 3, the first electronic device 301 may be positioned at a distance of the first distance (DIST1) apart from the adjacent second electronic device 302. The first electronic device 301 can sense environmental information, including temperature and humidity, at the location where the second electronic device 302 is placed and provide the sensed information.

According to an exemplary embodiment of the present disclosure, the second electronic device 302 is spaced apart from the first electronic device 301 by the first distance (DIST1) and is positioned at a distance substantially similar to the first distance (DIST1′) from the third electronic device 303. Additionally, the second electronic device 302 is spaced apart from the fourth electronic device 304 by a second distance (DIST2) and positioned at a distance substantially similar to the second distance (DIST2′) from the fifth electronic device 305.

According to an exemplary embodiment of the present disclosure, the second electronic device 302 can sense first environmental information, including temperature and humidity, corresponding to the position at the first distance (DIST1) or a position substantially similar to the first distance (DIST1′). Furthermore, the second electronic device 302 can sense second environmental information, including temperature and humidity, corresponding to the position at the second distance (DIST2) or a position substantially similar to the second distance (DIST2′).

According to an exemplary embodiment of the present disclosure, the second electronic device 302 cannot sense environmental information from the sixth electronic device 306 due to an excessive threshold distance, or the error in the sensed information is significant enough that it cannot be practically utilized. The environmental information based on the distances shown in FIG. 3 will be further described in detail with reference to FIG. 4.

FIG. 4 is a flowchart illustrating the sensing operation between electronic devices according to an exemplary embodiment of the present disclosure. FIG. 4 will be described in conjunction with FIG. 3.

According to an exemplary embodiment of the present disclosure, the second electronic device 302 can sense first environmental information (SENSE1), including temperature and/or humidity, for the first area (AREA1), which is adjacent to the space where it is positioned. In an exemplary embodiment, the second electronic device 302 can sense the first environmental information (SENSE1) for the first area (AREA1) while operating in the first mode.

According to an exemplary embodiment of the present disclosure, the second electronic device 302 can sense second environmental information (SENSE2), including temperature and humidity, for the second area (AREA2), which is spaced apart by the first distance (DIST1) or a distance substantially similar to the first distance (DIST1′). For example, the first electronic device 301 and the third electronic device 303 may be included in the second area (AREA2).

In an exemplary embodiment, the second electronic device 302 can sense the second environmental information (SENSE2) for the second area (AREA2) while operating in the second mode. According to an exemplary embodiment of the present disclosure, the first electronic device 301 can primarily sense environmental information at its deployed position, and the initially sensed value may be corrected, estimated, supplemented, interpolated, and/or verified based on the second environmental information sensed by the second electronic device 302 operating in the second mode. In summary, the second sensing device 302 not only generates sensing information for its own position through measurements in the first area (AREA1) but also supplements the sensing information of other devices by generating sensing information for their positions through measurements in the second area (AREA2).

According to an exemplary embodiment of the present disclosure, the second electronic device 302 can sense second environmental information (SENSE2), including temperature and humidity, for the second area (AREA2), which is spaced apart by the second distance (DIST2) or a distance substantially similar to the second distance (DIST2′). For example, the second area (AREA2) may include the first electronic device 301 and the third electronic device 303.

In an exemplary embodiment, the second electronic device 302 can sense the second environmental information (SENSE2) for the second area (AREA2) while operating in the second mode. According to an exemplary embodiment of the present disclosure, the first electronic device 301 can primarily sense environmental information at its deployed position, and the initially sensed value may be corrected, estimated, supplemented, interpolated, and/or verified based on the second environmental information sensed by the second electronic device 302 operating in the second mode. In summary, the second sensing device 302 not only generates sensing information for its own position through measurements in the first area (AREA1) but also supplements the sensing information of other devices by generating sensing information for their positions through measurements in the second area (AREA2).

In an exemplary embodiment, the second electronic device 302 can sense third environmental information (SENSE3) for the third area (AREA3) while operating in the second or third mode.

According to an exemplary embodiment, the second electronic device 302 can sense third environmental information (SENSE3), including temperature and humidity, for the third area (AREA3), which is spaced apart by the second distance (DIST2) or a distance substantially similar to the second distance (DIST2′). For example, the third area (AREA3) may include the fourth electronic device 304 and the fifth electronic device 305.

According to an exemplary embodiment, the second electronic device 302 can sense third environmental information (SENSE3) including temperature and humidity of the third area (AREA3), which contains an object of interest or has been designated as a region of interest (ROI), while operating in the third mode. For example, the third area (AREA3) may include the fourth electronic device 304 and the fifth electronic device 305.

According to an exemplary embodiment of the present disclosure, the fourth electronic device 304 or the fifth electronic device 305 can primarily sense environmental information at its deployed position, and the initially sensed value may be corrected, estimated, supplemented, interpolated, and/or verified based on the third environmental information sensed by the second electronic device 302 operating in the second or third mode. In summary, the second sensing device 302 not only generates sensing information for its own position through measurements in the first area (AREA1) but also supplements the sensing information of other devices by generating sensing information for their positions through measurements in the third area (AREA3).

As described above, according to an exemplary embodiment of the present disclosure, a multi-modal-based electronic device can sense environmental information, including temperature and humidity, for distant spaces rather than being limited to acquiring information for only the specific space where it is located, thereby improving sensing precision.

Additionally, according to an exemplary embodiment of the present disclosure, environmental information, including temperature and humidity, for a particular location can be redundantly sensed not only by an adjacent electronic device but also by a relatively distant electronic device. This redundancy helps compensate for malfunctions, missed measurements, or calibration of the directly adjacent electronic device, thereby increasing the reliability of the sensed information.

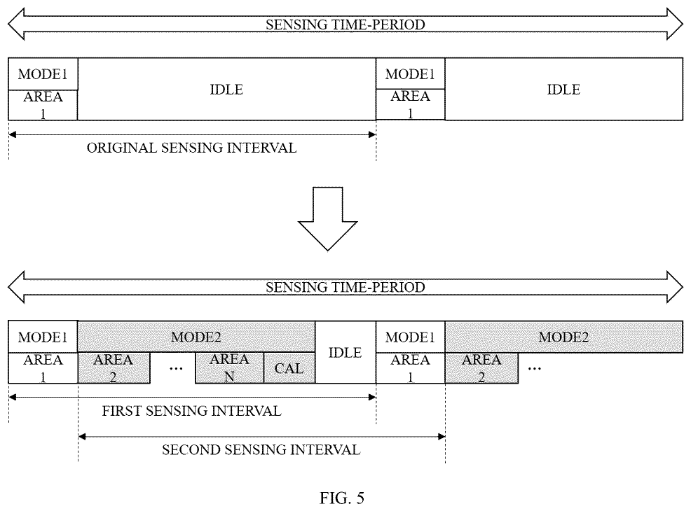

FIG. 5 is a conceptual diagram illustrating the operational modes of an electronic device 100 during sensing time periods according to an exemplary embodiment of the present disclosure. FIG. 1 and FIG. 4 are also referenced.

When the sensing of environmental information for a space begins, the electronic device 100 can operate in the first mode (MODE1). For example, the electronic device 100 in FIG. 1 can sense the first area (AREA1). In this case, the electronic device 100 can sense environmental information, including temperature and humidity, for its deployed position.

In an exemplary embodiment, an electronic device 100 that does not support multi-modal sensing may have a predetermined sensing cycle and remain in an idle state (IDLE mode) during the original sensing interval (ORIGINAL SENSING INTERVAL) until the next sensing instance in the first mode (MODE1).

In an exemplary embodiment, an electronic device 100 that supports multi-modal sensing may have a first sensing interval (FIRST SENSING INTERVAL) until the next sensing instance in the first mode (MODE1). For example, the electronic device 100 may sense in the first mode (MODE1) again after a time period equal to the first sensing interval (FIRST SENSING INTERVAL) from the previous sensing instance.

According to an exemplary embodiment of the present disclosure, a multi-modal-based electronic device 100 can operate in the second mode (MODE2) during the time between the first sensing operation in the first mode (MODE1) and the next sensing operation in the first mode (MODE1). For example, the original sensing interval (ORIGINAL SENSING INTERVAL), which is the time between two consecutive first mode (MODE1) sensing operations, may range from 5 to 30 minutes, while the actual sensing duration in the first mode (MODE1) typically lasts only a few seconds. Therefore, the additional power consumption and resource usage associated with the second mode (MODE2) may not significantly impact the overall available power time.

In an exemplary embodiment, a multi-modal-based electronic device 100 can operate in the second mode (MODE2) to sense the second area (AREA2) and obtain second environmental information. In another exemplary embodiment, the multi-modal-based electronic device 100 can operate in the second mode (MODE2) to sense the fourth area (AREA4) and obtain fourth environmental information. In yet another exemplary embodiment, the multi-modal-based electronic device 100 can operate in the second mode (MODE2) to sense the Nth first area (AREA N) and obtain Nth environmental information.

For example, while operating in the second mode (MODE2), the multi-modal-based electronic device 100 can sense environmental information in a region that is relatively farther than the first area (AREA1) sensed in the first mode (MODE1). The sensed environmental information can be used to supplement, correct, verify, and/or estimate the environmental data, including temperature and humidity, obtained through direct measurements by electronic devices positioned near the corresponding area.

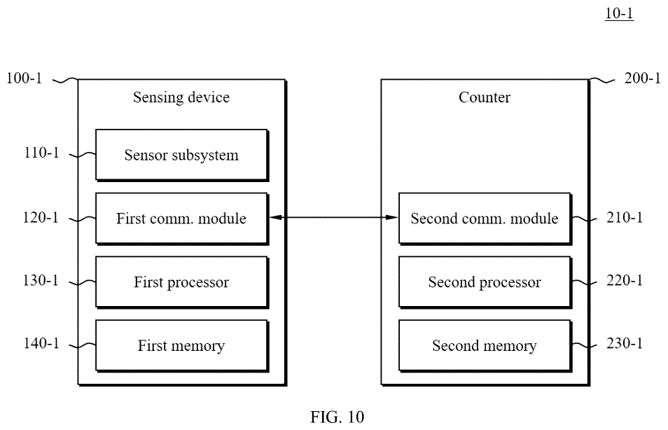

The exemplary embodiment describes a multi-modal-based electronic device 100 operating in a second mode, sensing environmental information from areas other than the first area (AREA1), and performing additional calculations (CAL) based on the sensed results. Further details regarding these additional calculations will be provided with reference to FIG. 9.

Although not explicitly illustrated in FIG. 5, the device can operate in a third mode within the time frame between sensing events in the first mode (MODE1). In an exemplary embodiment, the multi-modal-based electronic device 100 functions in the third mode when designated as a target device of interest, when the area where the device is installed is marked as an area of interest, or when it is placed within specific cargo (e.g., high-value goods such as batteries), thereby sensing environmental information related to the cargo's location.

According to an exemplary embodiment, the multi-modal-based electronic device 100 can operate in the second and/or third mode within the time interval between consecutive first mode (MODE1) sensing operations. For instance, after operating in the first mode (MODE1), the device can switch to the second mode (MODE2), enter an idle mode (IDLE), and then revert to the first mode (MODE1). Similarly, it may transition from the first mode (MODE1) to the third mode (MODE3), then enter idle mode before resuming the first mode (MODE1). Additionally, the device may sequentially operate in the first mode (MODE1), then the second mode (MODE2), followed by the third mode (MODE3), enter idle mode, and then return to the first mode (MODE1). Although not explicitly described, the multi-modal-based electronic device 100 can selectively enter various operational modes within the time frame between successive first mode (MODE1) sensing operations, enabling the acquisition of diverse environmental information.

In an exemplary embodiment of the present disclosure, a multi-modal based electronic device 100 can sense first environmental information (SENSE1) for a first time period in a first mode (MODE1) per first cycle, and can operate in a second mode for at least a portion of the remaining time excluding the first time period within the first cycle (MODE1).

According to the disclosed exemplary embodiment, an electronic device with a fixed sensing cycle can utilize idle time for sensing different spatial areas, thereby maximizing the efficiency of sensing resources.

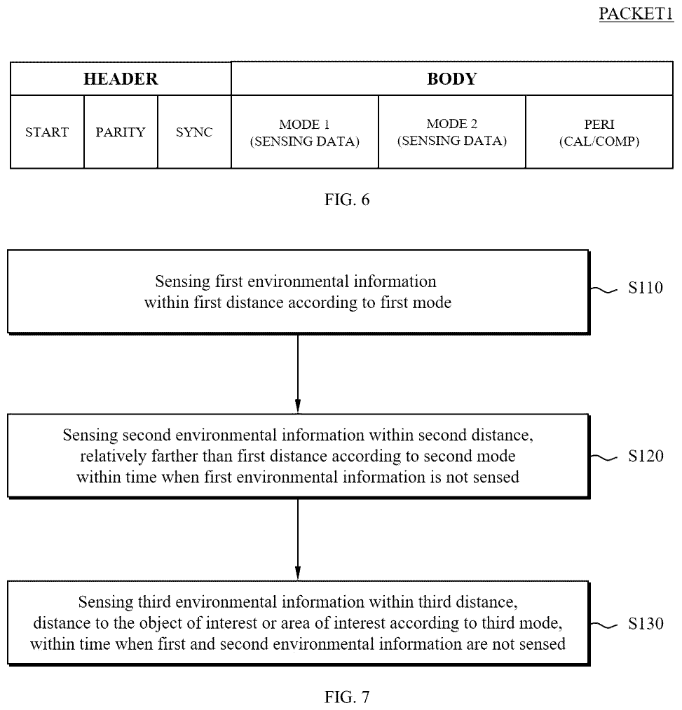

FIG. 6 is a block diagram illustrating a data packet (PACKET1) according to an exemplary embodiment of the present disclosure. The data packet (PACKET1) may include a header (HEAD) and a body (BODY).

The header (HEAD) may consist of start information (START), parity information (PARITY), and synchronization information (SYNC). The start information (START) may include condition information indicating when data sensing begins, hash information of the start trigger signal, and start time information. The parity information (PARITY) may represent a binary verification bit used to check whether the data stored in the header (HEAD) and body (BODY) satisfies predefined syntax and conditions, ensuring that there are no errors in data storage and verifying whether accumulated environmental data has been distorted or tampered with. The synchronization information (SYNC) may include synchronization information between the time at which environmental information is sensed and the actual stored time, verification information for verifying whether the sensed signals for each sensing cycle satisfy a predetermined sensing interval, and reference information for synchronizing to match the sensing interval if the sensing interval is not satisfied.

The body (BODY) may store environmental information sensed in different operational modes. For example, when the electronic device 100 operates in the first mode (MODE1), the body (BODY) may contain sensing data corresponding to the first environmental information. Similarly, when the device operates in the second mode (MODE2), the body (BODY) may store sensing data related to the second environmental information. Additionally, in the second mode (MODE2), the body (BODY) may include calibration (CAL) data for correction or supplementation, as well as compression information (COMP) containing details such as compression mode, compression ratio, and decoding information for data compression.

FIG. 7 is a flowchart illustrating the operational method of the electronic device 100 according to an exemplary embodiment of the present disclosure, referencing FIGS. 1 and 4.

In step S110, the electronic device 100 senses the first environmental information (SENSE1) within a first distance (DIST1) according to the first mode (MODE1).

In step S120, within the time frame when the first environmental information (SENSE1) is not being sensed, the device operates in the second mode (MODE2) to sense the second environmental information (SENSE2) at a second distance (DIST2), which is relatively farther than the first distance (DIST1).

In step S130, within the time frame when neither the first environmental information (SENSE1) nor the second environmental information (SENSE2) is being sensed, the device operates in the third mode (MODE3) to sense the third environmental information (SENSE3) within a third distance (DIST3), corresponding to the distance to the area or object of interest.

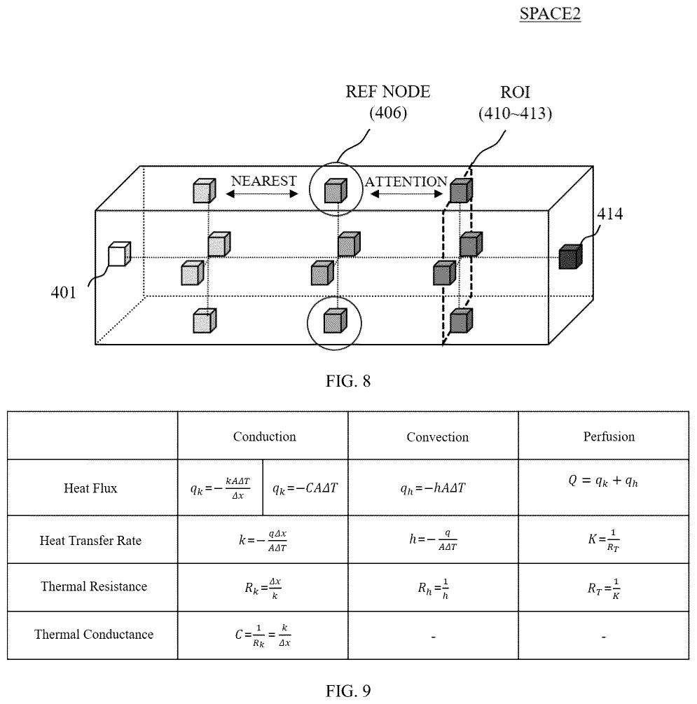

FIG. 8 is a conceptual diagram illustrating sensing operations in different modes of an electronic device according to an exemplary embodiment of the present disclosure.

Referring to FIG. 8, the first electronic device 401 may be associated with neighboring devices, including the second electronic device 402, third electronic device 403, fourth electronic device 404, and fifth electronic device 405. According to an exemplary embodiment, the sixth electronic device 406 may serve as a reference node (REF NODE) and can sense second environmental information through the second mode operation with the device closest to it (NEAREST).

Furthermore, in an exemplary embodiment, the sixth electronic device 406 can acquire sensing information related to attention (ATTENTION) space of the electronic device located in the region of interest (ROI). According to an exemplary embodiment of the present disclosure, the sixth electronic device 406 can sense environmental information regarding the positions of each of the electronic devices 410 to 413 included in the region of interest (ROI).

According to an exemplary embodiment, the electronic device may support multiple operational modes. For example, in the first operational mode, the device can store the connection relationship with the nearest electronic device that transmitted the first received synchronization signal among the multiple synchronization signals, and in the second operational mode, it can store the connection relationship with the electronic device of interest located in the region of interest (ROI) among the multiple synchronization signals.

FIG. 9 is a table related to a lookup table referenced by an electronic device according to an exemplary embodiment of the present disclosure.

Referring to FIG. 9, the lookup table may include at least one of heat transfer quantity, heat transfer rate, heat transfer resistance, and thermal conductance for at least one of heat conduction, heat convection, and heat permeation.

For example, the heat transfer quantity for conduction (thermal conduction quantity) may be expressed as q_k=−(kAΔT)/(Δx) or q_k=−CAΔT (unit: [W]). The heat transfer quantity for convection (thermal convection quantity) may be expressed as q_h=−hAΔT (unit: [W]), and the heat transfer quantity for permeation (thermal permeation quantity) may be expressed as Q=q_k+q_h (unit: [W]).

For example, the heat transfer rate for conduction (thermal conductivity) may be expressed as k=−(qΔx)/(AΔT) (unit: [W/(m*° C.)]), the heat transfer rate for convection (convective heat transfer coefficient) may be expressed as h=−q/(AΔT) (unit: [W/(m²° C.)]), and the heat transfer rate for permeation may be expressed as k=1/(R_T) (unit: [W/(m²*° C.)]).

For example, the thermal conductance for conduction may be expressed as R_k=(Δx)/k (unit: [(m²*° C.)/W]). In this case, the convective heat resistance (R_h) may be expressed as R_h=1/h (unit: [W/(m²*° C.)]), and the heat transfer rate for permeation may be expressed as K=1/R_T (unit: [W/(m²*° C.)]).

For example, the heat transfer resistance for conduction (thermal conduction resistance (R_k)) may be expressed as R_k=(Δx)/k (unit: [(m²° C.)/W]). In this case, the convective heat resistance (R_h) may be expressed as R_h=1/h (unit: [W/(m²*° C.)]), and the heat transfer rate for permeation may be expressed as K=1/(R_T) (unit: [W/(m²*° C.)]).

According to an exemplary embodiment, the electronic device 100 may have thermal conductance (C) for conduction and may utilize it for correcting sensing values.

According to an exemplary embodiment, the electronic device 100 may load at least one of heat transfer quantity, heat transfer rate, heat transfer resistance, and thermal conductance for at least one of heat conduction, heat convection, and heat permeation from the lookup table to derive a dependent variable value for an independent variable. The electronic device 100 may reference a lookup table that has precomputed results for heat conduction, heat convection, and heat permeation for specific values in the lookup table. This allows the device to derive results for environmental information values, including current temperature and humidity, without separate computation operations and apply these results for data correction and supplementation.

The present disclosure has been described with reference to the embodiments illustrated in the drawings. However, these embodiments are merely exemplary, and those skilled in the art will understand that various modifications and equivalent alternative embodiments are possible based on this disclosure. Accordingly, the true technical scope of the present disclosure should be defined by the technical spirit set forth in the appended claims.

### 2. Embodiment 2

Another embodiment is presented below. This embodiment illustrates a system that includes a counter and a sensing device for counting cargo inflow and outflow quantities, as well as its operation method. In the present disclosure, reference numerals in Embodiment 2 are assigned with the same numbers or characters as in the previously described Embodiment 1, but they should be understood to indicate different configurations.

FIG. 10 is a block diagram schematically illustrating a system 10-1 including a sensing device 100-1 and a counter 200-1 according to an exemplary embodiment of the present disclosure.

According to an exemplary embodiment, the sensing device 100-1 may sense cargo status information and environmental information by measuring temperature and humidity within a predetermined space or directly on a product. The counter 200-1 may count multiple sensing devices 100-1 when multiple sensing devices 100-1 are deployed. The system 10-1 may represent a computing system implementing a platform that includes at least one electronic device applying cargo visibility technology to visualize various information resulting from sensing the cargo status and environmental information.

Referring to FIG. 10, the sensing device 100-1 may include a sensor subsystem 110-1, a first communication module 120-1, a first processor 130-1, and a first memory 140-1. The counter 200-1 may include a second communication module 210-1, a second processor 220-1, and a second memory 230-1.

The sensor subsystem 110-1 may include at least one of a temperature sensor, an illumination sensor, a humidity sensor, a proximity sensor, an acceleration sensor, a gravity sensor (G-sensor), a gyroscope sensor, a motion sensor, an infrared sensor (IR sensor), a fingerprint recognition sensor, an optical sensor, an ultrasonic sensor, an infrared ray sensor, a magnetic sensor, an RGB sensor (illuminance sensor), a LiDAR (radar) sensor, a current sensor, an environmental sensor (e.g., barometric sensor, radiation detection sensor, thermal detection sensor, gas detection sensor), and a chemical sensor (e.g., healthcare sensor, biometric sensor, gas leak monitoring sensor), as well as virtual sensors that perform equivalent functions to the above-mentioned hardware sensors. However, the scope is not limited to these.

Here, the proximity sensor may be a sensor that detects the presence or absence of an object approaching a predetermined detection surface or existing nearby without mechanical contact by using electromagnetic force or infrared radiation. Such sensors may be incorporated within the sensor subsystem 110-1. As the functions of each sensor can be intuitively inferred from their names by those skilled in the art, detailed descriptions are omitted.

According to an exemplary embodiment of the present disclosure, the sensor subsystem 110-1 may sense cargo status information and environmental information by measuring temperature and humidity within a predetermined space or directly on a product.

The first communication module 120-1 may transmit various information obtained in the transportation space and/or transportation environment to other sensing devices, terminals, or servers. For example, the first communication module 120-1 may transmit at least one of sensing data, including temperature data, humidity data, vibration data, illumination data, acceleration data, gravity data, gas data, and other types of data sensed by the sensor subsystem 110-1, to other sensing devices, terminals, or servers. The first communication module 120-1 may communicate with the second communication module 210-1.

The first communication module 120-1 may communicate with external devices. Thus, the sensing device 100-1 may exchange information with external devices via a communication unit. For example, the sensing device 100-1 may use the first communication module 120-1 to communicate with external devices (e.g., the counter 200-1) so that the sensed and generated information in the logistics transportation environment can be shared. The first communication module 120-1 may include, for example, at least one of a wired communication module, a wireless communication module, a short-range communication module, and a location information module. The communication module according to an exemplary embodiment of the present disclosure may be configured to support short-range communication with another sensing device.

According to an exemplary embodiment of the present disclosure, the first communication module 120-1 may communicate with other sensing devices that are logically connected. According to another exemplary embodiment, the first communication module 120-1 may use various wireless communication methods, such as short-range communication, to transmit and receive various types of information, including sensing information, location information, and cargo information, with other sensing devices that are determined to be logically connected through processing by the first processor 130-1.

Here, communication, i.e., data transmission and reception, may be performed through wired or wireless means. To achieve this, the communication unit may be configured with a wired communication module that connects to the internet via a Local Area Network (LAN), a mobile communication module that connects to a mobile communication network through a base station to transmit and receive data, a short-range communication module that utilizes communication methods such as Wireless Local Area Network (WLAN) protocols like Wi-Fi, or Wireless Personal Area Network (WPAN) protocols like Bluetooth and Zigbee, a satellite communication module using Global Navigation Satellite System (GNSS) technologies such as Global Positioning System (GPS), or a combination of these modules. The wireless communication technology used for communication may be Narrowband Internet of Things (NB-IoT) for low-power communication. In this case, for example, NB-IoT technology may be an example of Low Power Wide Area Network (LPWAN) technology and may be implemented in standards such as LTE Cat (category) NB1 and/or LTE Cat NB2, but it is not limited to these specified names.

In an exemplary embodiment of the present disclosure, communication may include Bluetooth Low Energy (BLE) for low-power communication. For instance, BLE may feature a duty cycle of a few milliseconds (ms) and remain in sleep mode for most of the time, resulting in extremely low power consumption.

Additionally, or alternatively, the wireless communication technology implemented in wireless devices according to various embodiments may be based on LTE-M technology or 5G technology. For example, LTE-M technology may be an example of LPWAN technology and may also be referred to by various names such as enhanced Machine Type Communication (eMTC). Specifically, LTE-M technology may be implemented in at least one of various standards, including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, without being limited to these names.

Additionally, or alternatively, wireless communication technology implemented in wireless devices according to various embodiments may include at least one of ZigBee, Bluetooth, and Low Power Wide Area Network (LPWAN), which are designed for low-power communication. For instance, ZigBee technology may be based on IEEE 802.15.4 and may be used to establish personal area networks (PANs) for small-scale, low-power digital communication and may be known by various names.

A wired communication module may include various wired communication modules such as a Local Area Network (LAN) module, a Wide Area Network (WAN) module, and a Value Added Network (VAN) module. Additionally, it may include various cable communication modules such as USB (Universal Serial Bus), HDMI (High Definition Multimedia Interface), DVI (Digital Visual Interface), RS-232 (Recommended Standard 232), power line communication, or POTS (Plain Old Telephone Service).

A wireless communication module may include not only Wi-Fi and Wireless Broadband (WiBro) modules but also wireless communication modules that support various wireless communication methods, including GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long Term Evolution), 4G, 5G, and 6G.

The wireless communication module may include a wireless communication interface comprising an antenna and a transmitter for transmitting signals. Furthermore, under the control of the control unit, the wireless communication module may further include a signal conversion module that modulates digital control signals output from the control unit into analog wireless signals.

The wireless communication module may also include a wireless communication interface comprising an antenna and a receiver for receiving signals. Additionally, the wireless communication module may further include a signal conversion module that demodulates received analog wireless signals into digital control signals via the wireless communication interface.

A short-range communication module may support short-range communication using at least one of Bluetooth, RFID (Radio Frequency Identification), infrared communication (Infrared Data Association; IrDA), UWB (Ultra-WideBand), ZigBee, NFC (Near Field Communication), BLE (Bluetooth Low Energy), Wi-Fi (Wireless-Fidelity), Wi-Fi Direct, and Wireless USB (Wireless Universal Serial Bus).

A first communication module 120-1 may further include a location information module. The location information module is designed to obtain the location (or current location) of the sensing device 100-1 according to the present disclosure. Representative examples of this module include a GPS (Global Positioning System) module or a Wi-Fi module. For instance, by utilizing a GPS module, the location of the sensing device can be obtained using signals sent from GPS satellites. Alternatively, by using a Wi-Fi module, the location of the sensing device 100-1 may be determined based on information from a wireless access point (Wireless AP) that transmits or receives wireless signals with the Wi-Fi module. If necessary, the location information module may substitute or supplement other modules within the communication unit to acquire location-related data of the device. The location information module is a module used to obtain the location (or current location) of this device, and is not limited to a module that directly calculates or obtains the location of this device.

A first processor 130-1 may process, compress, correct, and estimate data sensed within a transport space by a sensing subsystem 110-1, as well as display the sensed data in an N-dimensional format, thereby comprehensively controlling the operation of the sensing device 100-1. The first processor 130-1 may communicate with a first memory 140-1 to execute at least one instruction stored therein.

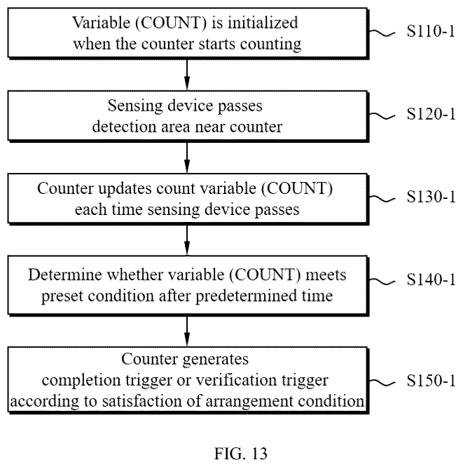

According to an exemplary embodiment of the present disclosure, the first processor 130-1 may interpret instructions to operate the sensing device 100-1 and direct its operational mode. In an exemplary implementation, the processor 130-1 may process sensing information, establish logical connections with other sensing devices in response to verification triggers received from a counter 200-1, generate a data structure representing the connection status of each sensing device, count the number of logically connected sensing devices, and respond with the count to the counter 200-1. This will be described in further detail in FIG. 13 and the following descriptions.

The first processor 130-1 may use data stored in the first memory 140-1 to perform the aforementioned operations, storing algorithms or programs that reproduce algorithms necessary to control the operation of components within the device. In this case, the first memory 140-1 and the first processor 130-1 may be implemented as separate chips, or they may be integrated into a single chip.

The first processor 130-1 may consist of one or multiple cores. In this case, one or multiple processors may be general-purpose processors such as CPUs, APs, or DSPs (Digital Signal Processors), graphics-specific processors such as GPUs or VPUs (Vision Processing Units), or AI-specific processors such as NPUs (Neural Processing Units). The processor(s) may control data processing according to predefined operational rules stored in memory or an AI model. Alternatively, if one or more processors are AI-dedicated processors, they may be designed with a hardware structure specialized for processing specific AI models.

The first memory 140-1 may store data supporting various functions of the device, programs for operating the control unit, input/output data (e.g., music files, still images, videos), and numerous application programs executed within the system. At least some of these application programs may be downloaded from external servers via wireless communication.

According to an exemplary embodiment of the present disclosure, the first memory 140-1 may store a verification coefficient variable (VRFCNT). A more detailed explanation regarding the verification coefficient variable (VRFCNT) will be provided below with reference to FIG. 13.

The first memory 140-1 may store at least one instruction. This first memory 140-1 may include various types of storage media such as flash memory type, hard disk type, solid-state disk (SSD) type, silicon disk drive (SDD) type, multimedia card micro type, card-type memory (e.g., SD or XD memory), random access memory (RAM), static random access memory (SRAM), read-only memory (ROM), electrically erasable programmable read-only memory (EEPROM), programmable read-only memory (PROM), magnetic memory, magnetic disk, and optical disk. Additionally, the first memory 140-1 may be a database that is separate from the system but connected via wired or wireless communication.

The sensing device 100-1 may generate sensing data (or sensing information) by sensing at least one of temperature, acceleration, humidity, illuminance, tilt, shock, and position inside a predetermined space (e.g., a cargo storage space or a cargo transport space) through the sensor subsystem 110-1. For example, the sensing device 100-1 may generate sensing data in real time or at predetermined intervals. The sensing device 100-1 may calculate a variation amount for the actual sensing data at each predetermined time interval and activate one of the first storage mode or the second storage mode based on the comparison result between the variation amount and a predetermined threshold variation amount.

According to an exemplary embodiment, the sensing device 100-1 may store sensing data using the storage method provided in the activated storage mode. Thus, by storing logistics status information, which includes at least one of temperature, acceleration, humidity, illuminance, tilt, shock, and position of the logistics being transported within a delivery vehicle, in a predetermined storage method, the sensing device 100-1 can reduce the data size required for storing and managing logistics status information.

Furthermore, the sensing device 100-1 may store status information in an electronic code format (e.g., QR code or barcode), allowing more data to be contained on a single page due to data compression, thereby improving the efficiency of logistics-related tasks. The electronic code may include various implementations such as barcodes, two-dimensional codes like QR codes, holograms, and three-dimensional codes based on depth cameras, without limitation in its form of implementation.

In the present disclosure, since the sensing device 100-1 can be attached or detached to a predetermined space or cargo, it can be affixed to a logistics transportation space and retrieved for reuse after the logistics transportation is completed. In an exemplary embodiment, at least one sensing device 100-1 may be arranged (attached) in the logistics transportation space.

Redundant descriptions of the second communication module 210-1 included in the counter 200-1 that overlap with those of the first communication module 120-1 are omitted. Similarly, redundant descriptions of the second processor 220-1 overlapping with those of the first processor 130-1, and the second memory 230-1 overlapping with those of the first memory 140-1, are omitted.

According to an exemplary embodiment of the present disclosure, the second communication module 210-1 may communicate with the first communication module 120-1. For instance, the counter 200-1 can detect that the sensing device 100-1 passes through an adjacent area by opening a communication channel with the first communication module 120-1 in the sensing device 100-1 passing through the counter 200-1 at an adjacent location through the second communication module 210-1.

According to an exemplary embodiment, the second processor 220-1 may determine the passage of the sensing device 100-1 based on the detected communication. Moreover, the second memory 230-1 may store a count variable (COUNT). For instance, upon the initiation of a counting operation, the second processor 220-1 may initialize the count variable (COUNT==0) stored in the second memory 230-1 and determine whether a sensing device has been detected within a predetermined time. Additionally, the second processor 220-1 may update the count variable (COUNT++) each time multiple sensing devices 100-1 pass through the counter 200-1. As a predetermined time elapses, the second processor 220-1 may determine whether the count value stored in the count variable satisfies a predetermined deployment condition. If the deployment condition is met, the second processor 220-1 may generate a completion trigger for external transmission, store the relative positions of at least one sensing device, and terminate the counting process. If the deployment condition is not met, the second processor 220-1 may generate a verification trigger and transmit it to the sensing device 100-1. At this time, the sensing device 100-1 may update the relay communication count with other sensing devices arranged within the predetermined space in the verification coefficient variable (VRFCNT) and respond with the total number of sensing devices in the predetermined space as the verification coefficient value. More details on this will be described with reference to FIG. 13 and the following figures.

According to an exemplary embodiment of the present disclosure, the counter 200-1 may be installed in a gantry form to allow at least one sensing device to pass through. For example, the sensing device 100-1 may pass through the center of the gantry-type counter 200-1. However, the counter 200-1 of the present disclosure is not limited to the aforementioned gantry shape and may be implemented in various other forms.

Although not illustrated in FIG. 10, the sensing device 100-1 may further include functional units required for sensing and information display, such as a display and input/output devices.

According to an exemplary embodiment, the input/output unit may include various interfaces or connection ports for receiving user input or outputting information to the user. The input/output unit may be divided into an input module and an output module.

The input module receives user input. It may process video information (or signals), audio information (or signals), data, or other user-provided information and may include at least one camera, at least one microphone, and at least one user input unit. Voice data or image data collected from the input module can be analyzed and processed with the user's control commands.

User input may take various forms, including key input, touch input, and voice input. Examples of input modules that can receive such user input include traditional keypads or keyboards, mice, touch sensors that detect user touches, microphones for voice input, cameras for recognizing gestures through image recognition, proximity sensors such as light sensors or infrared sensors for detecting user approach, motion sensors such as accelerometers or gyroscopes for detecting user movements, and various other input means that detect or receive user input in different ways.

According to an exemplary embodiment, a module provided in the sensing device 100-1 receives information from the user via the input module. Upon receiving input information, the first processor 130-1 may control the operation of the device accordingly. The user input unit may include hardware-based physical keys (e.g., buttons, dome switches, jog wheels, jog switches positioned on at least one of the front, rear, or side surfaces of the device) and software-based touch keys. For example, touch keys may be implemented as virtual keys, soft keys, or visual keys displayed on a touchscreen display panel through software processing or as touch keys positioned outside the touchscreen. The virtual or visual keys may take various forms and be displayed on the touchscreen as graphics, text, icons, videos, or combinations thereof.

An exemplary touch sensor may be implemented as a piezoelectric or electrostatic touch sensor that detects touch through a touch panel or touch film attached to a display panel, an optical touch sensor that detects touch by an optical method, etc. Additionally, the input module may be implemented as an input interface (e.g., USB port, PS/2 port) connecting to an external input device instead of detecting user input on its own.

The output module may output various types of information to the user, including display output, sound output via a speaker (and/or an amplifier), vibration output via a haptic device, and other output means. Furthermore, the output module may be implemented as a port-type output interface connecting to separate output devices.

The display-type output module, for example, can display text, still images, and videos. The term “display” encompasses a broad range of visual output devices, including but not limited to liquid crystal displays (LCDs), light-emitting diode (LED) displays, organic light-emitting diode (OLED) displays, flat panel displays (FPDs), transparent displays, curved displays, flexible displays, three-dimensional (3D) displays, holographic displays, projectors, and other devices capable of video output. These displays may also be integrated with a touch sensor of the input module to form a touch display.

According to an exemplary embodiment, information processed by the sensing device 100-1 may be transmitted to an intermediary manager's user terminal or a server (including a cloud server) for post-processing. The user terminal may include both computers and portable user terminals or may be in the form of one of them. The term “computer” includes, for example, laptops, desktops, and tablets equipped with a web browser, as well as slate PCs. Meanwhile, the portable user terminal includes wireless communication devices ensuring portability and mobility, such as Personal Communication Systems (PCS), Global System for Mobile Communications (GSM), Personal Digital Cellular (PDC), Personal Handyphone System (PHS), Personal Digital Assistants (PDA), International Mobile Telecommunication (IMT)-2000, Code Division Multiple Access (CDMA)-2000, Wideband Code Division Multiple Access (W-CDMA), Wireless Broadband Internet (WiBro) terminals, and smartphones. Wearable devices such as smartwatches, rings, bracelets, anklets, necklaces, glasses, contact lenses, and head-mounted devices (HMDs) are also included.

The server, as an external communication device, processes information and may include application servers, computing servers, database servers, file servers, game servers, mail servers, proxy servers, and web servers.

The components illustrated in FIG. 10 are not necessarily essential for implementing the system comprising the counter and at least one sensing device, nor for the operation method thereof. Therefore, the described system configuration may include more or fewer components than those listed.

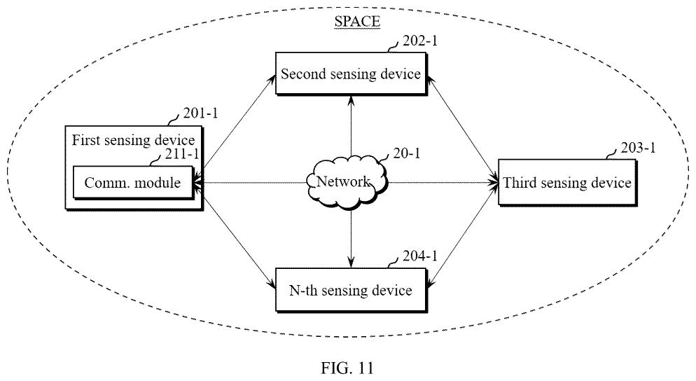

FIG. 11 is a conceptual diagram schematically illustrating the interrelation between multiple sensing devices in an exemplary embodiment of the present disclosure. According to an exemplary embodiment, multiple sensing devices 201, 202, 203, 204-1 may be arranged within a predetermined space (SPACE). The term “predetermined space (SPACE)” may refer to a physically compartmentalized area, such as the cargo compartment of a truck, the cargo storage of an airplane or ship, a transportation unit like a container box, reefer containers, liners, or any other space where goods are transported. However, the space is not necessarily defined by physical barriers and may include any area where a particular sensing device is located within a certain distance.

Referring to FIG. 11, the predetermined space (SPACE) may include a first sensing device 201-1 with a communication module 221-1, a second sensing device 202-1, a third sensing device 203-1, and an N-th sensing device 204-1.

The communication module 221-1 of the first sensing device 201-1 can communicate with the communication modules (not shown) of other sensing devices. For example, the first sensing device 201-1 can communicate with the second sensing device 202-1, the third sensing device 203-1, and the Nth sensing device 204-1, respectively, the second sensing device 202-1 can communicate with the first sensing device 201-1, the third sensing device 203-1, and the Nth sensing device 204-1, respectively, the third sensing device 203-1 can communicate with the first sensing device 201-1, the second sensing device 202-1, and the Nth sensing device 204-1, respectively, and the Nth sensing device 204-1 can communicate with the first sensing device 201-1, the second sensing device 202-1, and the third sensing device 203-1, respectively. Likewise, each sensing device can communicate with other nearby devices, forming a communication network 20-1 that supports short-range communication, long-range mobile communication, relay communication through a gateway, or relay communication connecting all sensing devices.

Among these components, the communication module may include one or more elements enabling communication with external devices. Examples include a broadcast reception module, wired communication module, wireless communication module, short-range communication module, and location information module.

The wireless communication module may support various wireless communication standards, including Wi-Fi, WiBro, GSM, CDMA, WCDMA, UMTS, TDMA, LTE, 4G, 5G, and 6G. It may also include a wireless communication interface with an antenna and transmitter for transmitting mobile communication signals and a mobile communication signal conversion module that modulates digital control signals from the controller into analog wireless signals. Additionally, the wireless communication module may include a wireless communication interface including an antenna and a receiver for receiving a mobile communication signal. In addition, the wireless communication module may further include a mobile communication signal conversion module for demodulating an analog wireless signal received through the wireless communication interface into a digital control signal.

According to an exemplary embodiment, when multiple sensing devices are positioned within a predetermined space, they can sequentially interoperate to count the number of sensing devices in that space.

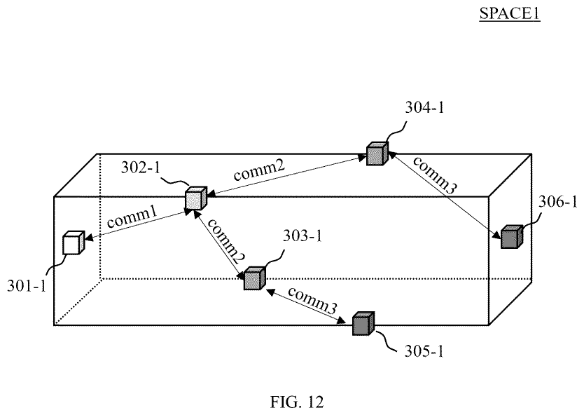

FIG. 12 is a conceptual diagram schematically illustrating sensing devices arranged within a predetermined space (SPACE1) according to an exemplary embodiment. For convenience, six sensing devices 301-1, 302-1, 303-1, 304-1, 305-1, 306-1 are shown in FIG. 12. However, the technical scope of the present disclosure is not limited to this configuration, and various numbers and arrangements of sensing devices may be implemented.

Referring to FIG. 12, the first sensing device 301-1 may be logically connected to an adjacent second sensing device 302-1 via communication (comm1). The first sensing device 301-1 may receive sensing information such as temperature and humidity detected at the location of the second sensing device 302-1. In an exemplary embodiment, in addition to sensing information, the first sensing device 301-1 may receive transportation information such as terminal-specific information, network bandwidth usage, location data, shipping and unloading information, and transportation route of the second sensing device 302-1. Similarly, the second sensing device 302-1 may receive sensing and/or logistics information from the first sensing device 301-1.

According to an exemplary embodiment, the second sensing device 302-1 may be logically connected to a third sensing device 303-1 and a fourth sensing device 304-1 via communication (comm2). The second sensing device 302-1 may further receive sensing information including temperature, humidity, etc. detected at each of the locations where the third sensing device 303-1 and the fourth sensing device 304-1 are deployed, and/or transportation information such as terminal-specific information, network bandwidth usage, location data, shipping and unloading information, and transportation route from the third sensing device 303-1 and the fourth sensing device 304-1. As described above, according to an exemplary embodiment, each of the third sensing device 303-1 and the fourth sensing device 304-1 may receive sensing information and/or logistics information from the second sensing device 302-1.

According to an exemplary embodiment of the present disclosure, the third sensing device 303-1 and the fourth sensing device 304-1 may have their initial connection communication with the second sensing device 302-1 made within a predetermined time period. In short, the third sensing device 303-1 and the fourth sensing device 304-1 may be treated as the same group as a result of being temporally closely connected to the second sensing device 302-1.

According to an exemplary embodiment, the third sensing device 303-1 may be logically connected by communicating (comm3) with the fifth sensing device 305-1, and the fourth sensing device 304-1 may be logically connected by communicating (comm3) with the sixth sensing device 306-1, and as described above, sensing information and various types of logistics information may be provided to each other.

According to an exemplary embodiment, since the third sensing device 303-1 and the fourth sensing device 304-1 can be treated as the same group as a result of being temporally closely connected to the second sensing device 302-1, the fifth sensing device 305-1 and the sixth sensing device 306-1 can similarly utilize the communication (comm3) network or be treated as the same group as a result of being logically connected from the same group.

According to an exemplary embodiment of the present disclosure, if each of the fifth sensing device 305-1 and the sixth sensing device 306-1 does not find a sensing device to be logically connected subsequently, the logical connection is terminated, and it can be assumed that all sensing devices within a given space (SPACE1) are logically connected. According to an exemplary embodiment of the present disclosure, a sensing device can maintain a connection relationship with all sensing devices located within a predetermined space, and can detect loss or theft of one or more sensing devices and/or cargo by receiving various information such as sensing information and location information from other sensing devices.

According to an exemplary embodiment of the present disclosure, if a sensing device that has received a first exploration signal further receives a first synchronization signal from another sensing device, it may cease generating its own synchronization signal. Since a logical connection between two different nodes has been completed, further coupling with other sensing devices, except for the closest one or those designated as interest areas or interest cargo, is no longer necessary.

According to an exemplary embodiment of the present disclosure, the connection tree must be unique to ensure data integrity. Therefore, once an exploration signal is generated, no additional exploration signal should be generated, and similarly, once a synchronization signal is generated, no additional synchronization signal should be generated. According to an exemplary embodiment of the present disclosure, each of the plurality of sensing devices 301-1 to 306-1 may generate an exploration signal and a synchronization signal only once. This prevents additional synchronization or exploration signals from being generated by other sensing devices, thereby suppressing node differentiation in the connection tree and ensuring the uniqueness of the connection tree.

Furthermore, in an exemplary embodiment, since each sensing device is connected to all other sensing devices arranged within a predetermined space, the system can determine whether the necessary number of sensing devices has been installed or retrieved. If the sensing devices are individually attached to cargo, the system can also verify whether the correct quantity of cargo has been loaded and/or unloaded.

According to an exemplary embodiment, the sensing devices may further include a light-emitting unit composed of an organic light-emitting diode (OLED) element. If all sensing devices are logically connected either permanently or temporarily through a trigger such as pressing a specific button, they may emit a first color (e.g., green). If any one of the sensing devices is not logically connected, they may emit a second color (e.g., red). Of course, other visual expressions through the light-emitting unit may be used to immediately inform users of the connection status or provide connection status information to a central control server.

FIG. 13 is a flowchart illustrating sensing operations between sensing devices according to an exemplary embodiment of the present disclosure. FIG. 13 will be described in conjunction with FIG. 12.

In step S110-1, the counter 200-1 initializes a count variable (COUNT) as it begins the counting process. According to an exemplary embodiment, the counter 200-1 initializes the count variable (COUNT) stored in the second memory 230-1 to COUNT==0 upon the start of the counting operation and determines whether a sensing device has been detected within a predetermined time. The counter 200-1 may store a pre-determined value for the time zone during which a sensing device 100-1 is expected to pass or for the expected operation time and determine whether the sensing device 100-1 has passed during the counting operation. For example, the counter 200-1 may determine whether the count value within an operation time (e.g., one hour) meets the predefined placement conditions for the sensing device 100-1.

In step S120-1, the sensing device 100-1 may pass through the detection area within the first distance of the counter 200-1. According to an exemplary embodiment, the counter 200-1 may determine the passage of the detected sensing device 100-1 through communication.

In step S130-1, the counter 200-1 updates the count variable (COUNT) each time the sensing device 100-1 passes through (COUNT++).

In step S140-1, the counter 200-1 determines whether the count value stored in the count variable meets the predefined placement conditions after a predetermined time has elapsed.

According to an exemplary embodiment, the counter 200-1 determines whether the sensing device 100-1 has been sufficiently deployed or removed as the expected passage time or operation time elapses and whether the count value stored in the count variable meets the predefined placement conditions.

In step S150-1, the counter 200-1 generates either a completion trigger or a verification trigger based on whether the placement conditions are met.

According to an exemplary embodiment, if the placement conditions are met, the counter 200-1 generates a completion trigger and transmits it externally, stores the relative positions of at least one sensing device, and terminates the counting process. For example, the counter 200-1 may transmit the completion trigger to a server (not shown), and a logistics integration system running on the server may monitor the cargo placement and status based on the sensing values.

According to an exemplary embodiment, if the placement conditions are not met, the counter 200-1 generates a verification trigger and transmits it to the sensing device 100-1. In this case, the sensing device 100-1 updates the verification count variable (VRFCNT) with the number of relay communications with other sensing devices placed in the predetermined space and responds with the total number of sensing devices within the space. For example, the counter 200-1 may instruct the sensing device 100-1 to perform relay communication with other sensing devices and compare the number of directly counted sensing devices with the number placed in the cargo transport space.

In an exemplary embodiment, the counter 200-1 determines the placement status. For example, based on the verification count value and the count value, the counter 200-1 may determine a placement status including cargo theft, sensing device non-removal, and exception-handled successful placement.

As described above, according to an exemplary embodiment of the present disclosure, a system including a counter and sensing devices can easily count the number of sensing devices deployed or collected in a cargo transport space or cargo loading space when the counter is installed therein. Additionally, since the counter electronically detects sensing devices passing through the adjacent area via communication, it is free from human error and improves work efficiency.

Furthermore, according to an exemplary embodiment, the system comprising the counter and sensing devices verifies the count value against the expected number of sensing devices. If there is a discrepancy, the system generates a verification trigger instructing the sensing devices to establish self-connections and perform counting, thereby enabling verification of the count.

Additionally, when sensing devices are directly attached to cargo, the system can effectively determine whether the cargo has been retrieved or stolen.

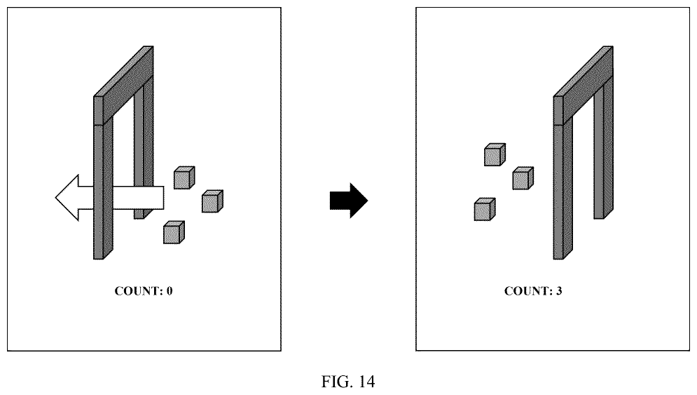

FIG. 14 is a conceptual diagram illustrating the counting operation of a system 10-1 comprising a sensing device 100-1 and a counter 200-1 according to an exemplary embodiment of the present disclosure.

According to an exemplary embodiment, the counter 200-1 may be installed in a gantry form to allow at least one sensing device to pass through. For example, the sensing device 100-1 may pass through the central area of the gantry-type counter 200-1. Of course, the counter 200-1 may be provided in various shapes and is not limited to the aforementioned gantry shape.

According to an exemplary embodiment, the counter 200-1 may communicate with the sensing device 100-1. For instance, the counter 200-1 may establish a communication channel with a sensing device 100-1 passing through an adjacent area to detect its passage.

According to an exemplary embodiment, the counter 200-1 may store the count variable (COUNT). For example, the second processor 220-1 may initialize the stored count variable (COUNT==0) upon the commencement of the counting operation and determine whether the sensing device 100-1 has been detected within a predetermined time. Furthermore, the counter 200-1 updates the count variable (COUNT) whenever multiple sensing devices 100-1 pass through it (COUNT++).

According to an exemplary embodiment, the count variable (COUNT) may initially be set to “0” before a sensing device 100-1 passes through and may be updated to “3” after three sensing devices have passed.

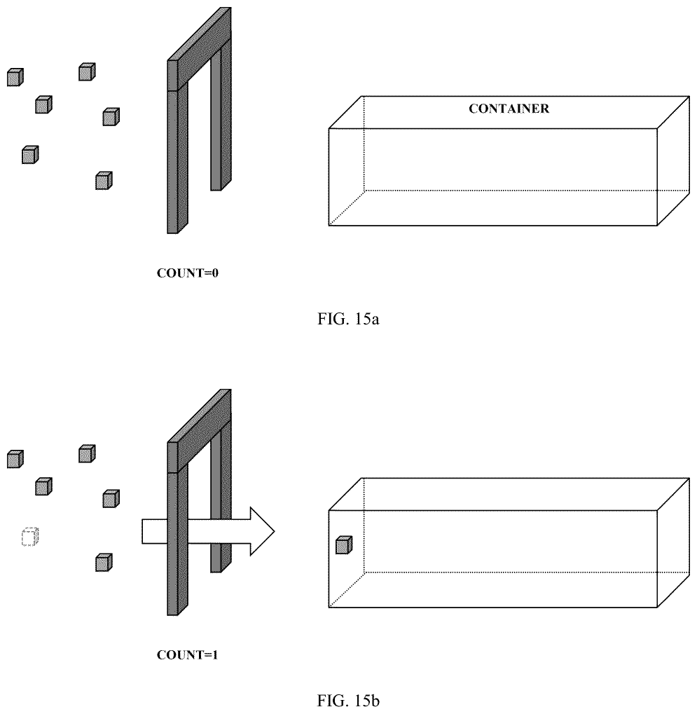

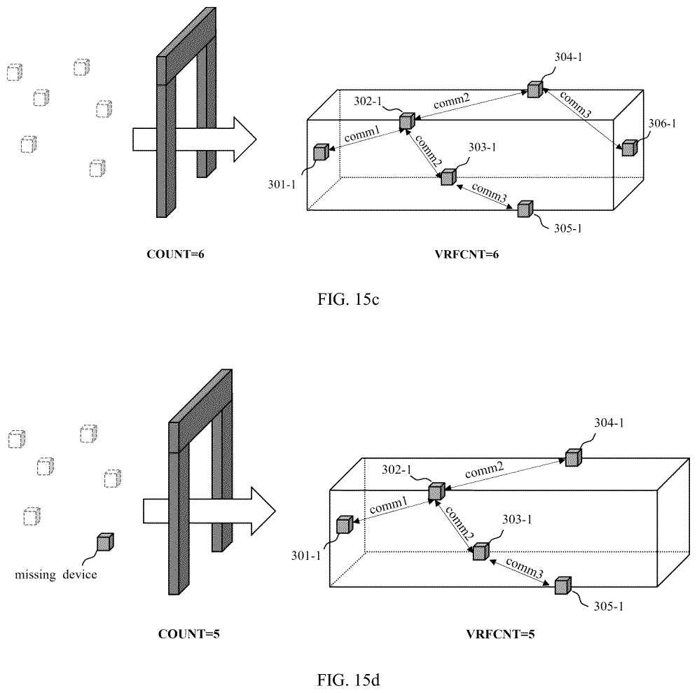

FIGS. 15a, 15b, 15c, and 15d are conceptual diagrams illustrating the counting operation of the system 10-1 comprising a sensing device 100-1 and a counter 200-1 according to an exemplary embodiment of the present disclosure.

Referring to FIG. 15a, the pre-placement state of the cargo or the transport space for the delivery target items, as well as the pre-placement state of the sensing devices, is depicted. In this disclosure, it is assumed that six sensing devices are deployed. The sensing device 100-1 can generate sensing data (or sensing information) related to at least one of the internal temperature, acceleration, humidity, illumination, tilt, impact, and position of the predefined space (e.g., cargo loading space or cargo transport space) in which the transport target items are placed. According to an exemplary embodiment of the present disclosure, the count variable may be initialized to “0.”

Referring to FIG. 15b, the counter 200-1 determines whether the sensing device 100-1 has been detected within a predefined time. As the sensing device 100-1 passes through a detection area within the detectable range of the counter 200-1, the counter 200-1 determines the passage of the detected sensing device 100-1 through communication. For example, the sensing device 100-1 and the counter 200-1 may establish a communication channel via short-range communication technologies such as BLE, beacon signals, or NFC.

According to an exemplary embodiment of the present disclosure, the counter 200-1 updates the count variable (COUNT) each time the sensing device 100-1 passes through (COUNT++). For instance, referring to FIG. 15b, when one sensing device 100-1 is placed in the cargo transport space (CONTAINER), the count variable (COUNT) is updated to store “1.”

Referring to FIG. 15c, six sensing devices may be deployed in the cargo transport space (CONTAINER). The counter 200-1 counts the six sensing devices and updates the count variable (COUNT) to “6.”

In an exemplary embodiment of the present disclosure, the counter 200-1 generates a completion trigger based on the fulfillment of placement conditions and sends it externally, storing the relative positions of at least one sensing device, and may terminate the counting process. For example, the counter 200-1 can send the completion trigger to the server (not shown), and a logistics integration system running on the server can monitor the placement and status based on the sensing values of the cargo.

In an exemplary embodiment of the present disclosure, the counter 200-1 generates a validation trigger and sends it to one of the sensing devices. The sensing device 301-1, which receives the validation trigger first, can communicate with other sensing devices. The first sensing device 301-1 can communicate with other sensing devices (comm1), and the second sensing device 302-1 can communicate with the third 303-1 and fourth sensing devices 304-1 (comm2). The third sensing device can communicate with the fifth sensing device 305-1, and the fourth sensing device 304-1 can communicate with the sixth sensing device 306-1 (comm3).

In the exemplary embodiment, the first sensing device 301-1 updates the verification counter variable (VRFCNT) with the number of relay communications with other sensing devices 302-1, 303-1, 304-1, 305-1, 306-1 placed together in the cargo space (CONTAINER), and can respond to the counter 200-1 with the verification count value of “6,” which is the total number of sensing devices in the space.

For example, the counter 200-1 instructs the sensing device 100-1 to relay communication with other sensing devices, and compares the number of devices counted directly with the number placed in the cargo space (CONTAINER). In this exemplary embodiment, the counter 200-1 checks whether the count value stored in the count variable meets the predefined placement condition after a certain period and can determine whether the placement is correct.

Referring to FIG. 15d, five sensing devices may be placed in the cargo transport space (CONTAINER), and one sensing device may not be placed in the cargo transport space (missing device). The counter 200-1 can update the count variable (COUNT) to “5” as a result of counting five sensing devices.

In an exemplary embodiment, the counter 200-1 generates a validation trigger when the placement condition is not met (COUNT+6).

In another exemplary embodiment, the counter 200-1 generates a validation trigger and sends it to one of the sensing devices. The sensing device 301-1 receiving the validation trigger first can communicate with other sensing devices. The first sensing device 301-1 can communicate with other sensing devices (comm1), and the second sensing device 302-1 can communicate with the third 303-1 and fourth sensing devices 304-1 (comm2). The third sensing device 303-1 can communicate with the fifth sensing device 305-1, and the fourth sensing device 304-1 does not communicate with other sensing devices. The first device 301-1 can receive information from each sensing device by creating a communication channel, and can confirm that the total number of logically connected sensing devices transmitted through the sensing devices is 5, and respond to the counter 200-1 with the number “5” of the total number of sensing devices within a predetermined space as a verification coefficient value (CRFCNT=5).

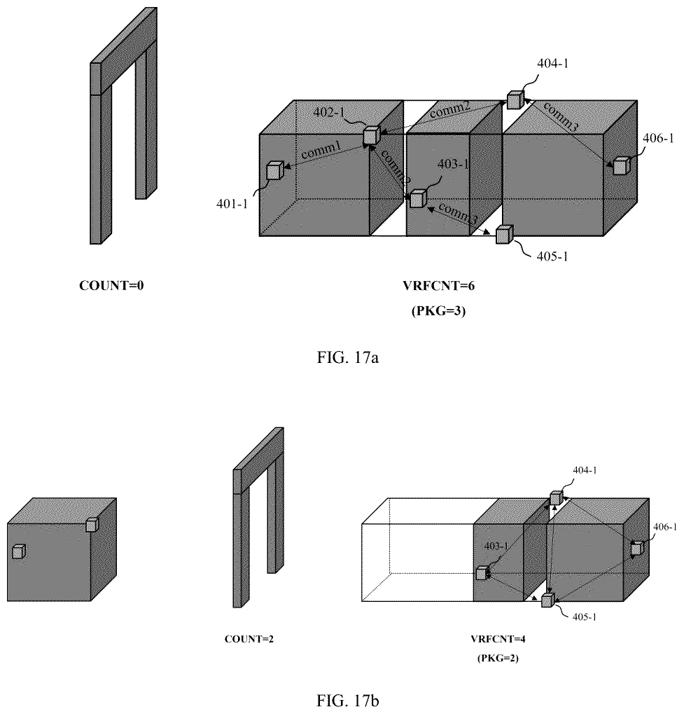

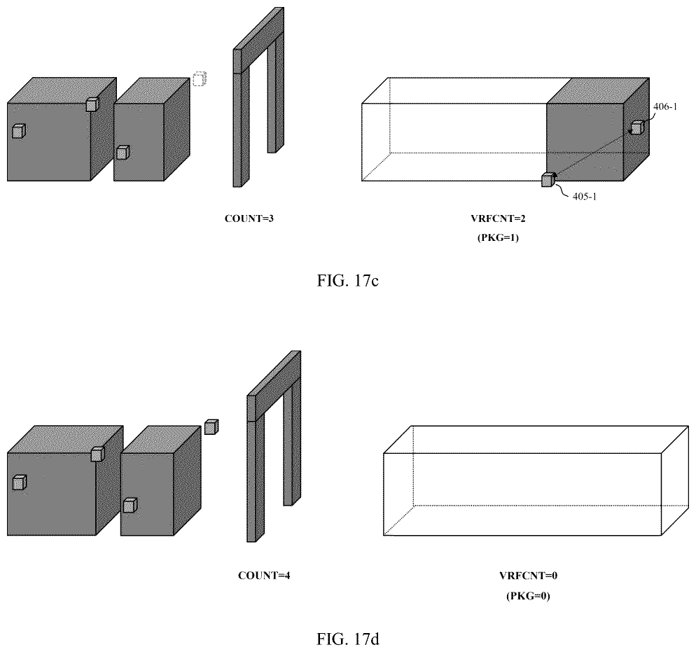

The system 10-1 confirms that the count variable (COUNT) and the verification counter variable (VRFCNT) have the same value of 5 and can determine that one of the sensing devices is missing from the cargo transport space. For example, the system 10-1 can determine a cargo theft state, a sensing device non-removal state, and an exception-handled placement success state based on the similarity or difference between the count variable (COUNT) and the verification counter variable (VRFCNT). This will be described in more detail with reference to FIG. 17a to FIG. 17d.

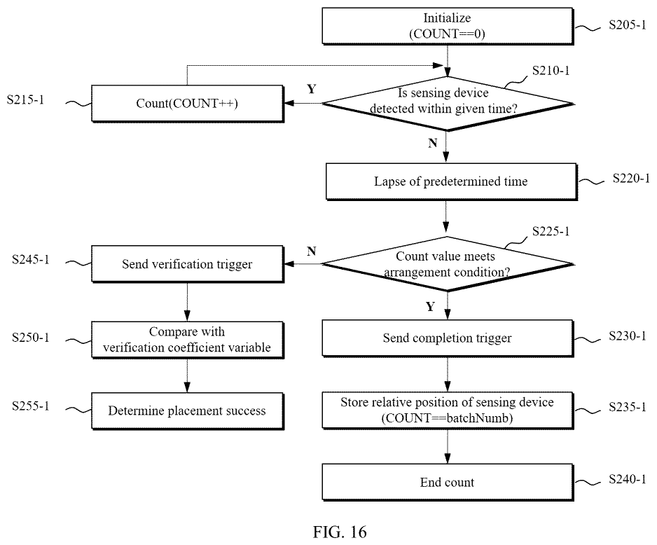

FIG. 16 is a flowchart explaining the operation of the system 10-1 according to an exemplary embodiment of the present disclosure.

In step S205-1, initialization (COUNT==0) may be performed. For example, the counter (100-1) may reset the previously stored count variable (COUNT) to 0 when the counting mode starts and prepare for a new counting operation.

In step S210-1, it is determined whether a sensing device has been detected within a predetermined time. For example, the counter 200-1 can store predetermined values for a preset counting expected time, a cargo loading time, or other time zones during which the sensing device 100-1 can pass, or an expected working time.

In step S215-1, the counting operation (COUNT++) is performed. For example, the counter 200-1 can determine the passage of a sensing device 100 during the counting operation. At this time, the count variable (COUNT) is updated by 1 each time the sensing device 100-1 passes.

In step S220-1, after a certain period, the counter 200-1 can determine whether the count value meets the placement condition (step S225-1).

In step S230-1, the completion trigger transmission operation may be performed. For example, the counter 200-1 generates a completion trigger when the count value meets the predefined placement condition (COUNT=batchNumb), and the system 10-1 can update the placement status and synchronization information of the sensing device 100-1 and monitor the environmental information in the cargo transport space on the logistics integration platform.

In step S235-1, the operation of storing the relative position of the sensing device (COUNT==batchNumb) may be performed. In an exemplary embodiment, the counter 200-1 receives the relative position information of each sensing device in response to the completion trigger from the sensing device 100-1. In an exemplary embodiment, the system 10-1 can receive the relative positions of the sensing devices either through the counter 200-1 or directly through the sensing device 100-1.

In step S240-1, a counting termination operation may be performed. For example, the counter 200-1 may complete the counting operation and may not perform an additional counting operation, and may terminate the communication channel established with the sensing device 100-1.

In step S245-1, the validation trigger transmission operation may be performed. For example, the counter 200-1 can generate a completion trigger and a verification trigger when the count value satisfies a predetermined batch condition (COUNT=batchNumb), and the system 10-1 can update the batch status and synchronization information of the sensing device 100-1 to perform environmental information monitoring on a cargo transport space on a logistics integration platform. For example, the counter 200-1 can generate a verification trigger when the count value does not satisfy a predetermined batch condition (COUNT=/=batchNumb).

In step S250-1, the comparison operation for the validation counter (VRFCNT) may be performed. For example, the sensing device 100-1 can update the verification counter variable (VRFCNT) by performing relay communication with other sensing devices. The counter 200-1 compares the verification counter variable value stored in VRFCNT with the count value stored in COUNT.

In step S255-1, the placement success determination operation may be performed. For example, the system 10-1 determines whether the cargo theft state, sensing device non-removal state, or exception-handled placement success state is based on the similarity or difference between the count variable (COUNT) and the verification counter variable (VRFCNT).

FIGS. 17a, 17b, 17c, and 17d illustrate conceptual diagrams of the counting operation of the system 10-1 through the sensing device 100-1 and counter 200-1 according to an exemplary embodiment of the present disclosure. In the exemplary embodiment, FIG. 17a to FIG. 17d can be referenced to describe determining whether sensing devices are normally recovered after a task or counting the amount of cargo entry and exit. Here, the counter 200-1 can be used to count the quantity of sensing devices 100-1 released and separated from the cargo transport space and taken out.

Referring to FIG. 17a, the state after arranging the transport space for cargo or items to be delivered and the state after arranging the sensing device are illustrated. The present disclosure assumes that six sensing devices are placed. The six sensing devices 401-1, 402-1, 403-1, 404-1, 405-1, 406-1 are normally placed, and each sensing device can maintain communication (comm1, comm2, comm3), with the verification counter variable (VRFCNT) storing a value of “6.” According to an exemplary embodiment, the system 10-1 can determine that “3” cargo packages (PKG) are correctly positioned according to the predefined sensing device placement shape in the cargo transport space. The counter 200-1 can be initialized (COUNT=0).

Referring to FIG. 17b, the counter 200-1 determines whether the sensing device 100-1 has been detected within a predetermined time. The counter 200-1 can determine the passage of a sensing device detected through communication when two sensing devices pass through a detection area within a detectable range. For example, the sensing device 100-1 and the counter 200-1 can create a communication channel through short-range communication such as BLE, a beacon signal, or NFC. As a result, the counter 200-1 can update the count variable (COUNT) to “2”.

In the exemplary embodiment, the sensing devices 403-1, 404-1, 405-1, 406-1 in the cargo transport space can perform relay communication, and each sensing device updates the verification counter variable (VRFCNT) to “4.” According to an exemplary embodiment, the system 10-1 can determine that “2” cargo packages (PKGs) are normally positioned when the number of sensing devices is reduced by two according to the sensing device arrangement shape within the predefined cargo transport space. For example, the system 10-1 can determine that a case in which some cargo is removed is a normal state with exception processing even if the verification coefficient variable is an exception value rather than a normal value.

Referring to FIG. 17c, the counter 200-1 can determine whether the sensing device 100-1 is detected within a predetermined time. The counter 200-1 can determine the passage of the sensing device detected through communication as one sensing device passes further through the detection area, which is a distance within the detectable range, and as a result, the counter 200-1 can update the count variable (COUNT) to “3”.

According to an exemplary embodiment of the present disclosure, the sensing devices 405-1, 406-1 within a cargo transport space can perform relay communication, and each of the sensing devices can update the verification coefficient variable (VRFCNT) to “2”. According to an exemplary embodiment, the system 10-1 can determine that there is “1” cargo package (PKG) if the number of sensing devices is reduced by two according to a predefined arrangement shape of the sensing devices within the cargo transport space. For example, the system 10-1 can determine that the verification coefficient variable value is 2 while the coefficient variable value is 3, and determine that the sum of the coefficient variable value and the verification coefficient variable value is different from 6, which is the initial number of sensing devices arranged, and determine that the sensing device is in an unrecovered state.

Referring to FIG. 17d, the counter 200-1 can determine whether the sensing device 100-1 is detected within a predetermined time, and can update the count variable (COUNT) to “4”. According to an exemplary embodiment of the present disclosure, the counter 200-1 can generate a verification trigger according to a placement condition not being met (COUNT=/=6). In an exemplary embodiment, the counter 200-1 can generate and broadcast the verification trigger.

According to an exemplary embodiment of the present disclosure, if there is no sensing device in the cargo transport space, the system 10-1 can determine that the verification coefficient variable is “0”. The system 10-1 can determine that the verification coefficient variable value is 0 while the coefficient variable value is 4, and that the sum of the coefficient variable value and the verification coefficient variable value is different from 6, which is the number of sensing devices deployed, and determine that the sensing device is in an unrecovered state and the package is in a stolen or lost state.

While the present disclosure has been described with reference to the embodiments illustrated in the drawings, these embodiments are merely exemplary. Those skilled in the art will understand that various modifications and equivalent alternative embodiments are possible. Therefore, the true technical scope of the present disclosure should be determined by the technical ideas specified in the appended claims.

### 3. Components of Embodiment 2

claim 1: A system comprising a counter and at least one sensing device, the system including: A first communication module configured to support communication, A sensor subsystem configured to sense environmental information including temperature or humidity, A first processor configured to process sensing information, A first sensing device including a first memory storing a verification count variable (VRFCNT), A second communication module configured to support communication, A second processor configured to determine whether the sensing device passes through a memory storing a counting variable (COUNT) and communication, and A counter.

Claim 2: The system of claim 1, wherein the counter is installed in a gantry structure allowing at least one sensing device to pass through.

Claim 3: The system of claim 1, wherein the counter initializes the count variable (COUNT) and determines whether a sensing device is detected within a predetermined p period upon initiating counting.

Claim 4: The system of claim 3, wherein the counter updates the count variable (COUNT) each time at least one sensing device passes through.

Claim 5: The system of claim 4, wherein the counter determines whether the count value stored in the count variable meets a predetermined placement condition as the predetermined time elapses.

Claim 6: The system of claim 5, wherein the counter generates a completion trigger and transmits it to the outside when the placement condition is satisfied, stores the relative position of each of at least one sensing device, and terminates the counting.

Claim 7: The system of claim 5, wherein the counter claim 5, w generates a verification trigger and transmits it to the first sensing device when the placement condition is not met.

Claim 8: The system of claim 7, wherein the first sensing device updates the relay communication count with other sensing devices placed together in a predetermined space into the verification count variable (VRFCNT), and responds with the total number of sensing devices in the predetermined space as the verification count value.

Claim 9: The system of claim 8, wherein the counter determines a placement status, including a cargo theft state, an unremoved sensing device state, and an exception-handled successful placement state based on the verification count value and count value.

Claim 10: A method of operating a system comprising a counter and at least one sensing device, the method including: initializing, via the counter, the count variable (COUNT) as the counter begins counting; passing, via the at least one sensing device, through a detection area within a first distance from the counter; updating, via the counter, the count variable (COUNT) each time the at least one sensing device passes through; determining, via the counter, whether the count value stored in the count variable meets a predetermined placement condition as the predetermined time elapses; and generating, via the counter, a completion trigger or a verification trigger based on whether the placement condition is met.

1. A multi-modal based electronic device comprising:
at least one instruction and a memory storing a lookup table;
a sensor subsystem configured to sense environmental information, including temperature or humidity, within different distances depending on operating mode; and
a processor configured to operate the electronic device by interpreting the instructor and to direct the operating mode,
wherein the operating mode comprises:
a first mode for sensing first environmental information within a first distance;
a second mode for sensing second environmental information within a second distance greater than the first distance;
a third mode for sensing third environmental information within a third distance corresponding to an object of interest or a region of interest;
sense the first environmental information for a first duration in each first cycle under the first mode,
operate in the second mode for a second duration during at least a portion of a remaining time within the first cycle excluding the first duration, and
operate in the third mode for a third duration during at least a portion of a remaining time excluding both the first duration and the second duration within the first cycle.

2. (canceled)

3. (canceled)

4. The multi-modal based electronic device according to claim 1, wherein the electronic device operating in the second mode is used for the calibration of third environmental information sensed by another electronic device located within the second distance.

5. (canceled)

6. (canceled)

7. The multi-modal based electronic device according to claim 1, wherein the lookup table includes at least one of heat transfer quantity, heat transfer rate, heat transfer resistance, and thermal conductance related to at least one of thermal conduction, thermal convection, and thermal transmittance.

8. The multi-modal based electronic device according to claim 1, wherein the electronic device is directly attached to a cargo loading space for transportation or to the cargo itself.

9. The multi-modal based electronic device according to claim 1, further comprising a communication module configured to support near-field communication with other electronic devices.

10. A sensing method for environmental information, including temperature or humidity, in a multi-modal based electronic device, the method comprising:
sensing first environmental information within a first distance according to a first mode;
sensing second environmental information within a second distance that is relatively farther than the first distance according to a second mode during the time when the first environmental information is not being sensed; and
sensing third environmental information within a third distance, which is the distance to an object of interest or a region of interest, according to a third mode during the time when neither the first nor the second environmental information is being sensed,
wherein the sensing of the first environmental information includes storing information indicating a connection relationship with at least one electronic device located within the first distance, or with at least one electronic device located adjacent to an object of interest within an area of interest.
